(19) United States
(12) Patent Application Publication
(10) Pub. No.: US 2026/0148395 A1
(43) Pub. Date: May 28, 2026

(54) IMAGING APPARATUS, CONTROL METHOD, AND MEDIUM

(71) Applicant: CANON KABUSHIKI KAISHA, Tokyo (JP)

(72) Inventor: HIROKI SAEGUSA, Tokyo (JP)

(21) Appl. No.: 19/395,734

(22) Filed: Nov. 20, 2025

(30) Foreign Application Priority Data
Nov. 25, 2024 (JP) 2024-204612

(51) Int. Cl. G06T 7/33; G06T 7/73

(52) U.S. Cl. CPC G06T 7/33; G06T 7/73; G06T 2207/30196; G06T 2207/30204

(57) ABSTRACT

In some embodiments, an imaging apparatus detects a feature point in a captured image, determines a type corresponding to a feature point being a target of positional alignment with a guide, based on a positional relationship between a feature point detected in a first captured image and the guide, and outputs leading information to lead to alignment of a position of a feature point corresponding to the type, out of feature points detected in a second captured image, with a position of the guide, based on a positional relationship between the feature point corresponding to the type and the guide.

### BACKGROUND

### Field of the Technology

The present disclosure relates to a technique of guide display by an imaging apparatus and imaging leading.

### Description of the Related Art

As an assistance in a case of performing imaging by an imaging apparatus, a technique of displaying a guide individually set by a user of the imaging apparatus (hereinafter, referred to as a "photographer") on a display device, such as a liquid crystal display included in the imaging apparatus, has been known. For example, Japanese Patent Laid-Open No. 2017-118210 (hereinafter, referred to as "PTL 1") discloses a technique of customizing a display form of the guide by changing a width of a grid displayed on the display device of the imaging apparatus according to manipulation by the photographer.

However, in the conventional technique disclosed in PTL 1, although the imaging apparatus displays the guide individually set by the photographer, it is impossible to specify which position of a subject to be imaged (hereinafter, referred to as a "subject") the displayed guide is to be aligned with. Therefore, the conventional technique has had a problem that the imaging apparatus cannot output information to lead to alignment of a positional relationship between the guide and the subject. Therefore, it has been impossible to perform imaging properly.

### SUMMARY

An imaging apparatus, according to some embodiments of the present disclosure, detects a feature point in a captured image, determines a type corresponding to a feature point being a target of positional alignment with a guide, based on a positional relationship between a feature point detected in a first captured image and the guide; and outputs leading information to lead to alignment of a position of a feature point corresponding to the type, out of feature points detected in a second captured image, with a position of the guide, based on a positional relationship between the feature point corresponding to the type and the guide.

Additional features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a diagram describing a use case according to embodiment 1

FIG. 2 is a diagram showing a relationship between FIGS. 2A and 2B.

FIGS. 2A and 2B are diagrams illustrating an example of a workflow in the use case according to embodiment 1.

FIGS. 3A and 3B are diagrams illustrating an example of a display screen displayed on a display device included in an imaging apparatus according to embodiment 1.

FIG. 4 is a diagram illustrating an example of a method of outputting leading information according to embodiment 1.

FIG. 5 is a block diagram illustrating an example of a hardware configuration of the imaging apparatus according to embodiment 1.

FIG. 6 is a block diagram illustrating an example of a functional configuration of the imaging apparatus according to embodiment 1.

FIG. 7 is a diagram illustrating an example of feature point information according to embodiment 1.

FIG. 8 is a diagram illustrating an example of guide information according to embodiment 1.

FIG. 9 is a flowchart illustrating an example of a flow of processing by the imaging apparatus according to embodiment 1.

FIG. 10 is a diagram illustrating an example of an imaging mode selection screen according to embodiment 1.

FIG. 11A is a diagram illustrating an example of a guide selection screen to select a basic shape of a guide according to embodiment 1, and FIGS. 11B and 11C are diagrams illustrating an example of an adjustment screen to adjust a display position of the guide.

FIG. 12 is a flowchart illustrating an example of a detailed processing flow of target determination processing by the imaging apparatus according to embodiment 1.

FIGS. 13A and 13B are diagrams describing an example of the target determination processing by a target determination unit according to embodiment 1.

FIG. 14 is a diagram illustrating an example of a selection screen of a target candidate according to embodiment 1.

FIG. 15 is a flowchart illustrating an example of a detailed processing flow of leading output processing by the imaging apparatus according to embodiment 1.

FIG. 16 is a diagram showing a relationship between FIGS. 16A and 16B;

FIGS. 16A and 16B are diagrams illustrating an example of a workflow in a use case according to embodiment 2.

FIG. 17 is a diagram illustrating an example of an adding proposal screen according to embodiment 2.

FIG. 18 is a block diagram illustrating an example of a functional configuration of the imaging apparatus according to embodiment 2.

FIG. 19 is a flowchart illustrating an example of a flow of processing by the imaging apparatus according to embodiment 2.

FIG. 20 is a flowchart illustrating an example of a flow of adding proposal processing by the imaging apparatus according to embodiment 2.

FIG. 21 is a diagram illustrating an example of the feature point information that is a judgement target of a feature point in a recommendation generation unit according to embodiment 2.

FIG. 22 is a diagram illustrating an example of a case where the feature points are plotted on the same plane according to embodiment 2.

FIG. 23 is a diagram illustrating an example of the guide generated by the recommendation generation unit according to embodiment 2.

### DESCRIPTION OF THE EMBODIMENTS

Hereinafter, with reference to the attached drawings, the present disclosure describes example embodiments. Configurations shown in the following embodiments are merely exemplary, and some embodiments are not limited to the configurations shown.

### Embodiment 1

At a scene of shooting school photographs and the like, there is a case of imaging of each of many persons in a similar composition. In such a case, it is required to shorten the imaging time for each person. An embodiment 1 is described using a use case of the above-described case as an example.

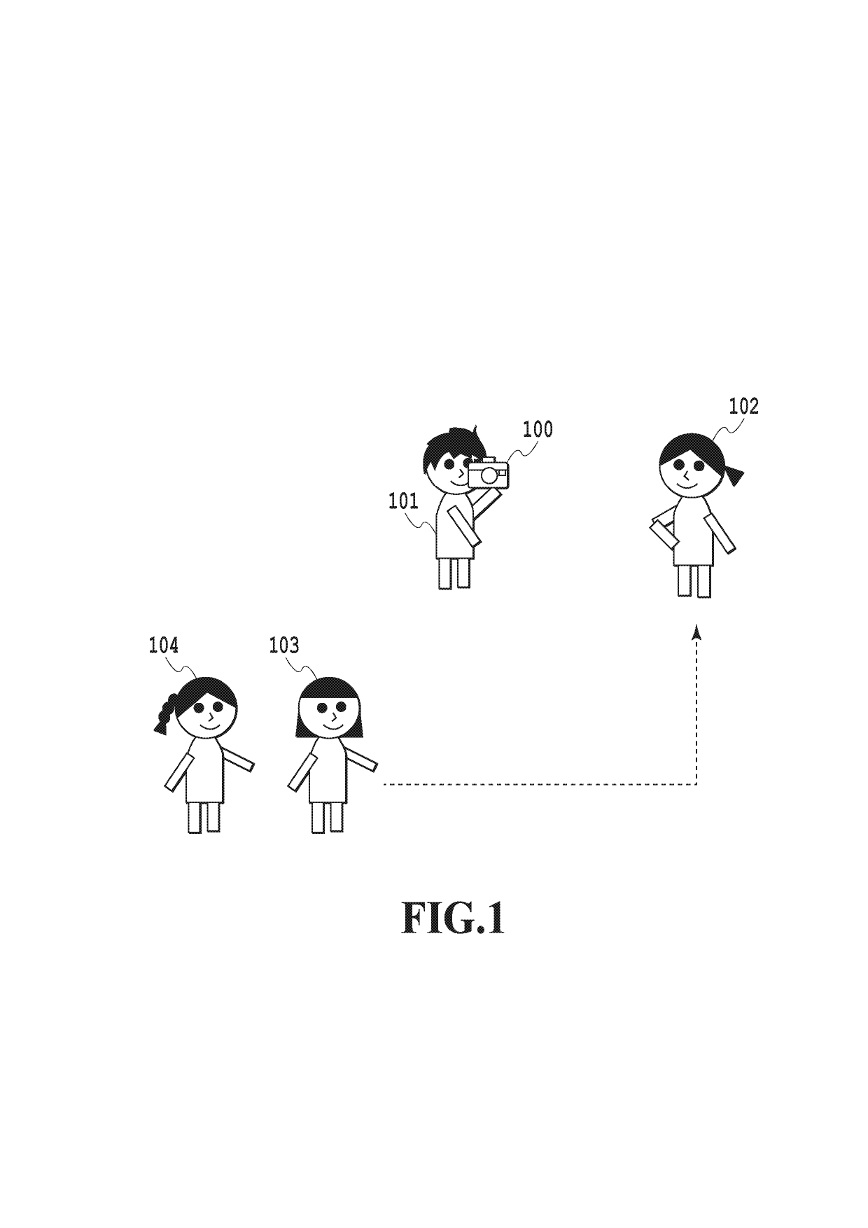

FIG. 1 is a diagram describing the use case according to the embodiment 1. A photographer 101 manipulates an imaging apparatus 100 and sequentially performs imaging of each of persons 102 to 104 as subjects. Specifically, the photographer 101 poses each of the persons 102 to 104 in a similar pose to each other and performs imaging. The imaging apparatus 100 is an apparatus having at least an imaging function and a live view function, such as a digital still camera, a digital video camera, or a smartphone.

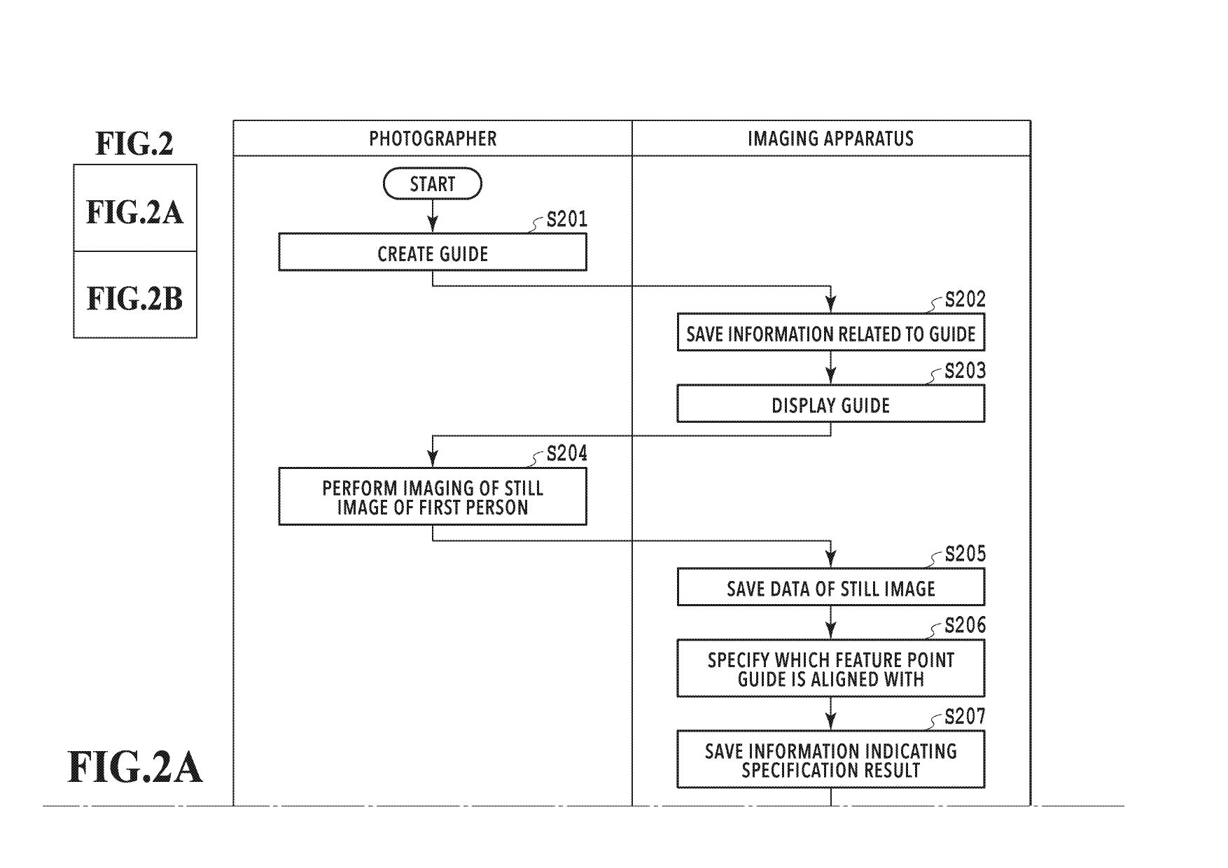

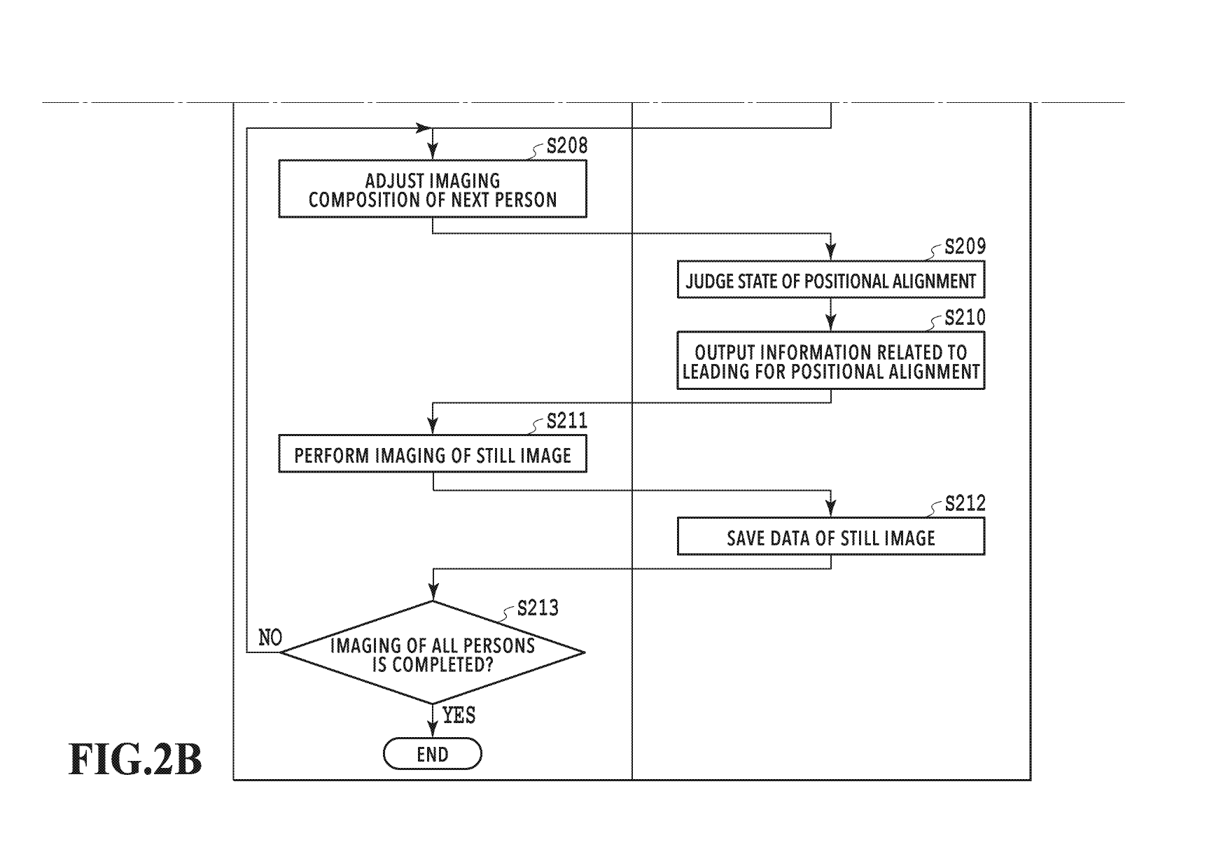

FIGS. 2A and 2B illustrate an example of a workflow in the use case according to embodiment 1. Note that each step in the workflow described below is described using a reference sign starting with "S." First, in S201, the photographer 101 creates a guide by manipulating the imaging apparatus 100. The guide is a frame line and the like that are displayed on a display device included in the imaging apparatus 100 to assist the photographer 101 in a case where the photographer 101 determines the imaging composition. In the present embodiment, it is described that the photographer 101 creates the guide by manipulating the imaging apparatus 100; however, the guide may be created by information equipment, such as a personal computer (PC). In this case, for example, the photographer 101 allows the imaging apparatus 100 to read information related to the guide created by using the information equipment.

Next, in S202, the imaging apparatus 100 saves the information related to the guide created by the photographer 101 in S201 into a storage device and the like included in the imaging apparatus 100. Next, in S203, the imaging apparatus 100 reads out the information related to the guide that is saved in S202 and displays the guide indicated by the information on the display device included in the imaging apparatus 100.

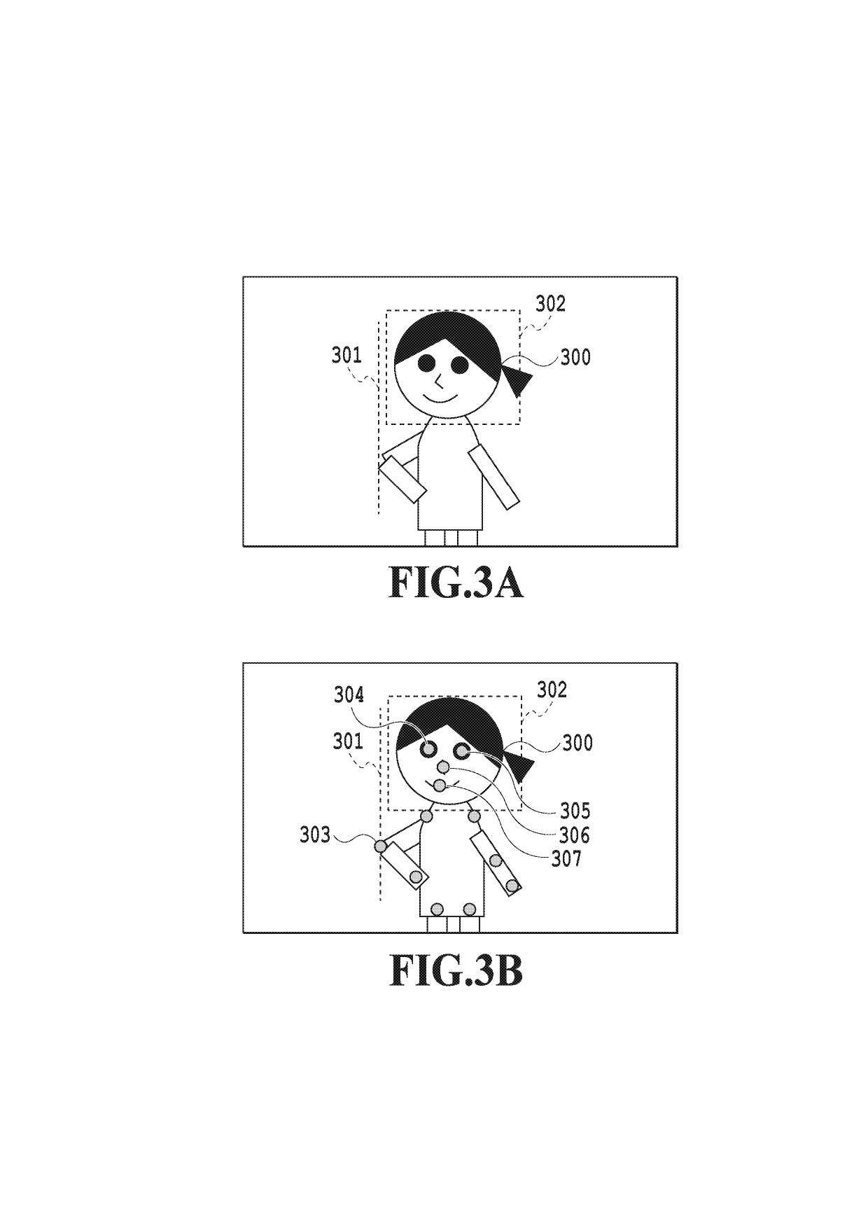

FIGS. 3A and 3B are diagrams illustrating an example of a display screen displayed on the display device included in the imaging apparatus 100 according to embodiment 1. Specifically, FIG. 3A illustrates an example of a display form of the guide. Each of broken lines 301 and 302 indicates the guide, and the guide is expressed by a line, a frame, a combination thereof, or the like. The imaging apparatus 100 assists the photographer 101 to perform imaging of each of the persons 102 to 104 in compositions that are similar to each other by displaying the guide. FIG. 3B is described later.

After S203, in S204, in a state in which the guide is displayed on the display device included in the imaging apparatus 100, the photographer 101 performs imaging of a first person (e.g., the person 102) as the subject of an image, such as a still image. Next, in S205, the imaging apparatus 100 saves data on the image obtained by imaging in S204 (hereinafter, referred to as a "captured image") into the storage device and the like included in the imaging apparatus 100. Next, in S206, based on a position of the guide and a position of a feature point in a representation 300 of the first person (the person 102) that is obtained by analyzing the captured image obtained by imaging the first person, the imaging apparatus 100 executes detection processing described below. Specifically, in the detection processing based on the position of the guide and the position of the feature point in the representation 300 of the person 102, the imaging apparatus 100 specifies which feature points the guides indicated by the broken lines 301 and 302 correspond to.

FIG. 3B illustrates an example of the positions of the feature points extracted from the captured image obtained by imaging in S204. In FIG. 3B, each of circles 303 to 307 in gray color indicates a position of a feature point in the representation 300 of the first person (the person 102). Specifically, the circle 303 is a position corresponding to a right elbow of the first person that is extracted as the position of the feature point in the captured image. Likewise, the circles 304 to 307 are positions corresponding, respectively, to a right eye, a left eye, a nose, and a mouth of the first person that are extracted as the positions of the feature points in the captured image.

In FIG. 3B, the guide having a linear shape indicated by the broken line 301 crosses the position of the feature point corresponding to the right elbow of the first person in the captured image. In this case, for example, the imaging apparatus 100 specifies that the guide indicated by the broken line 301 is the guide for aligning the position of the representation of the right elbow in a case of imaging. Additionally, in FIG. 3B, the feature points corresponding to the right eye, the left eye, the nose, and the mouth of the first person in the captured image are included within a frame of the guide having a frame shape indicated by the broken line 302. In this case, for example, the imaging apparatus 100 specifies that the guide indicated by the broken line 302 is the guide for aligning the position of the representations of the right eye, the left eye, the nose, and the mouth in a case of imaging.

After S206, in S207, the imaging apparatus 100 saves information indicating a result of the specification in S206 into the storage device and the like included in the imaging apparatus 100. Next, in S208, in order to perform subsequent imaging, the photographer 101 adjusts the imaging composition of the next person while confirming a live view in a state in which the guide is displayed on the display device included in the imaging apparatus 100.

Next, in S209, the imaging apparatus 100 judges a state of the positional alignment between the position of the guide being displayed and the position of the representation of the person in the live view. Specifically, for example, the imaging apparatus 100 judges whether a positional relationship between the guide and the representation of the person is proper by using the information indicating the result of specification in S206 that is saved in S207. In the example illustrated in FIG. 3B, the imaging apparatus 100 judges whether the representation of the right elbow of the person overlaps the guide indicated by the broken line 301. Additionally, the imaging apparatus 100 judges whether the representations of the right eye, the left eye, the nose, and the mouth exist within the guide indicated by the frame of the broken line 302. In the judgement in S209, if it is judged that the position of the representation of the person is improper with respect to the guide, in other words, if the positions are misaligned, in S210, the imaging apparatus 100 outputs information (hereinafter, referred to as "leading information") related to leading to alignment of the position of the representation of the person.

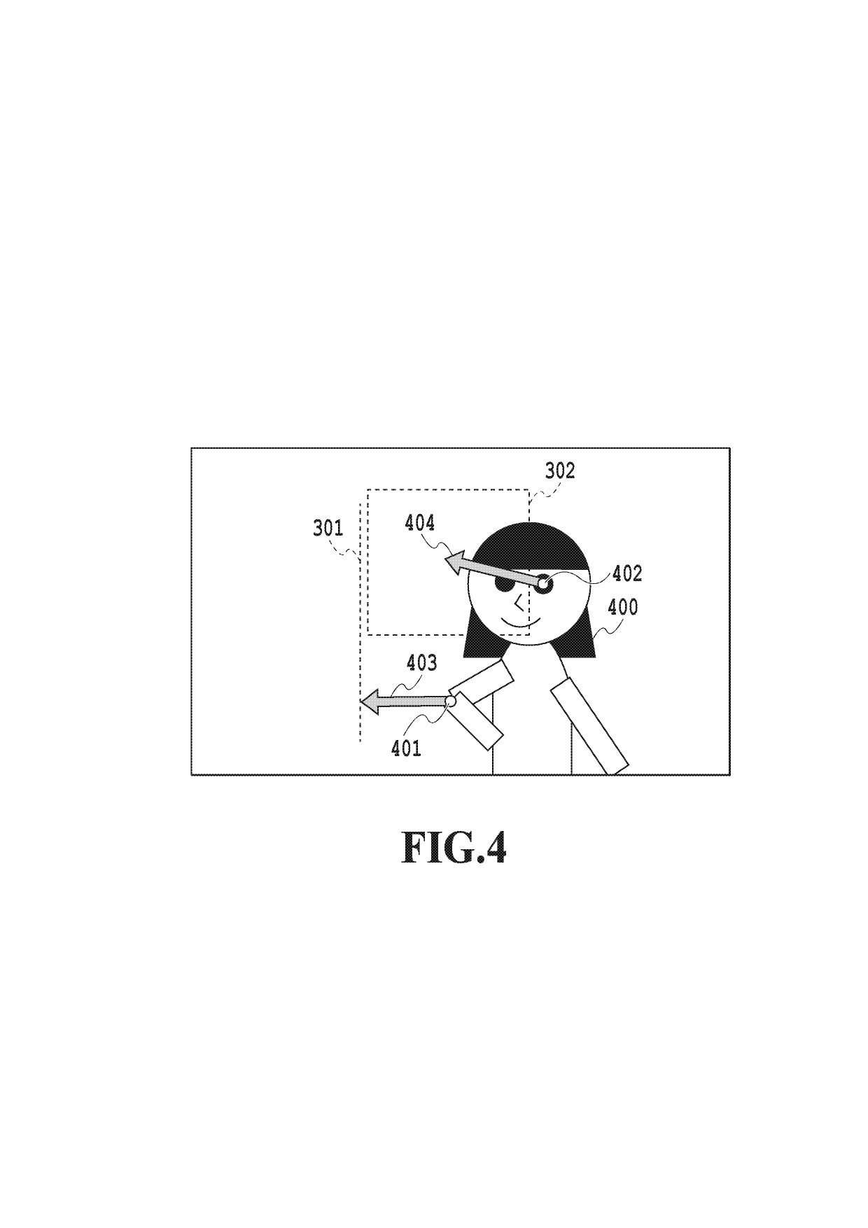

FIG. 4 is a diagram illustrating an example of a method of outputting the leading information according to embodiment 1. For example, the imaging apparatus 100 outputs the leading information by displaying a graphical user interface (GUI) corresponding to the leading information so as to superimpose the GUI on the display of the live view in a state in which the guide is being displayed. In FIG. 4, circles 401 and 402 each indicate the position of the feature point in a representation 400 of the person 103 that is an improper position with respect to the guide indicated by the broken line 301 or 302. Arrows 403 and 404 indicate directions in which the positions of the feature points in the representation 400 of the person 103, which are indicated by the circles 401 and 402, should be moved, respectively, and the arrows 403 and 404 are an example of an output form of the leading information. For example, the arrows 403 and 404 are each expressed by a line segment including a starting point, which is a current position of the feature point in the position that should be moved, and an ending point, which is a position to which the position of the feature point should be moved according to the guide. Note that, for example, in a case of the feature point that should be included within the guide having the frame shape indicated by the broken line 302 like the feature point indicated by the circle 402, the position of the ending point of the arrow 404 may be the center or the approximate center of the frame shape.

The photographer 101 changes at least one of the position and the posture of the person and the position and the posture of the imaging apparatus 100 so as to obtain the proper imaging composition by repeatedly performing the processing in S208 while confirming the outputted content of the leading information in S210. After the adjustment of the imaging composition is completed, in S211, the photographer 101 performs imaging to obtain a captured image, such as a still image. Next, in S212, the imaging apparatus 100 saves data on the captured image obtained by imaging in S211 into the storage device and the like included in the imaging apparatus 100. Next, in S213, the photographer 101 confirms whether imaging of all the persons as the subjects to be imaged is completed. If imaging of at least a part of the persons as the subjects to be imaged is not completed, the processing from S208 to S213 is repeatedly executed until imaging of all the persons as the subjects to be imaged is completed. If imaging of all the persons as the subjects to be imaged is completed, the processing of the workflow illustrated in FIGS. 2A and 2B ends.

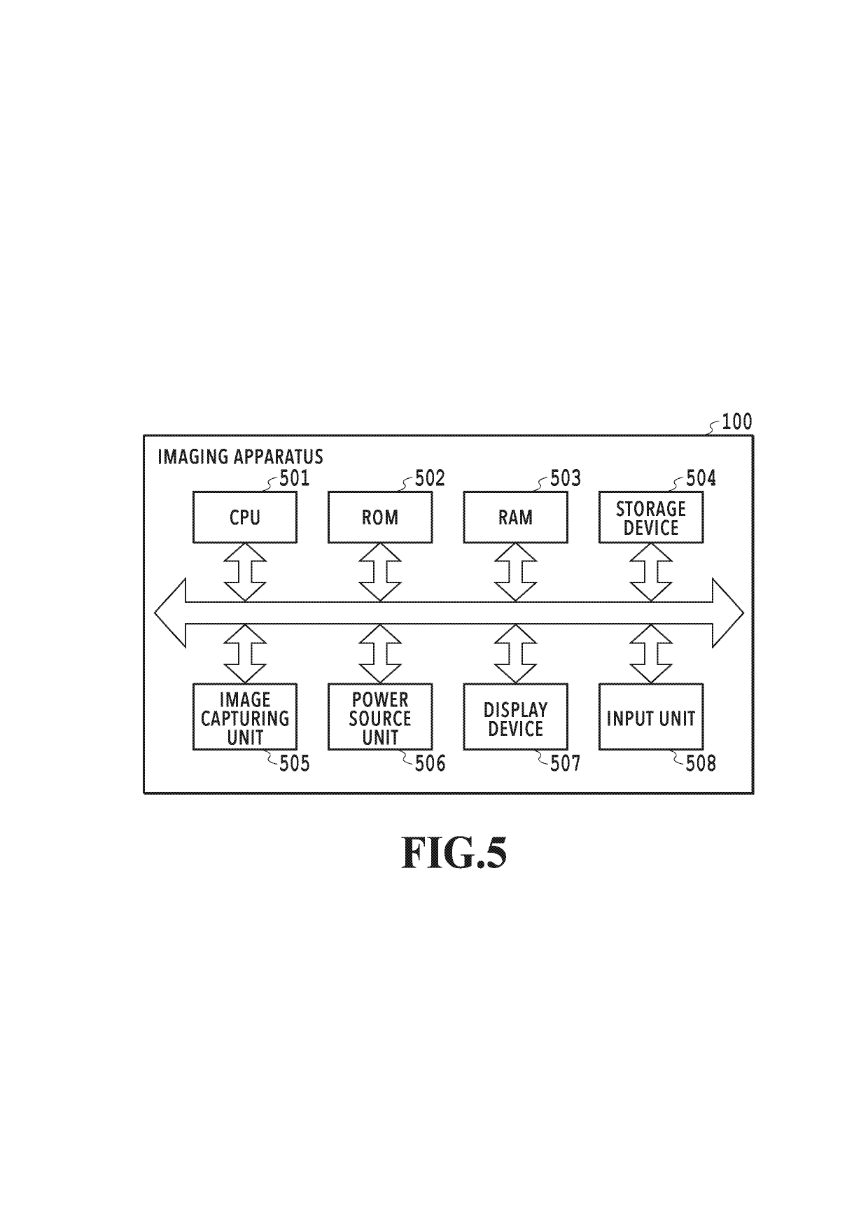

FIG. 5 is a block diagram illustrating an example of a hardware configuration of the imaging apparatus 100 according to the embodiment 1. The imaging apparatus 100 includes, as a hardware configuration, a CPU 501, a ROM 502, a RAM 503, a storage device 504, an image capturing unit 505, a power source unit 506, a display device 507, and an input unit 508. Additionally, the above-described hardware configuration is communicably connected to each other via a bus. The CPU 501 is a control unit formed of at least one processor or circuit and controls, overall, the imaging apparatus 100. The ROM 502 is a memory that can perform deleting and recording electrically, and the information related to the guide created in S201 and data, a program, and the like used for computation by the CPU 501 are stored. Note that, the program mentioned herein is a computer program to execute various flowcharts described later. The RAM 503 operates as a working area of the CPU 501, and a constant and a variable used for the computation by the CPU 501 and the program and the like read out from the ROM 502 by the CPU 501 are deployed.

The storage device 504 is a recording medium formed of a semiconductor memory or the like, such as a memory card, and records the data on the captured image obtained by imaging. Note that, the information related to the guide created in S201 may be stored in the storage device 504. The image capturing unit 505 is an image sensor formed of an element, such as a charge coupled device (CCD), a complementary metal oxide semiconductor (CMOS), or the like, that converts an optical representation into an electric signal. Additionally, the image capturing unit 505 includes multiple microlenses on a sensor surface and can measure the distance of the subject based on a phase difference.

The power source unit 506 supplies the imaging apparatus 100 with power. For example, the power source unit 506 is formed of an internal battery, such as a lithium-ion battery, a detachable portable battery, or the like. The configuration of the power source unit 506 is not limited thereto and may be formed of an AC/DC converter or the like, for example. In this case, the power source unit 506 may supply the imaging apparatus 100 with power by converting the power supplied from an AC power source into a DC power source. The display device 507 is formed of a liquid crystal monitor, an electronic finder, or the like and displays the guide, the live view, or various GUIs. The input unit 508 is formed of a touch panel, a button switch, or the like and accepts a manipulation input from the photographer 101.

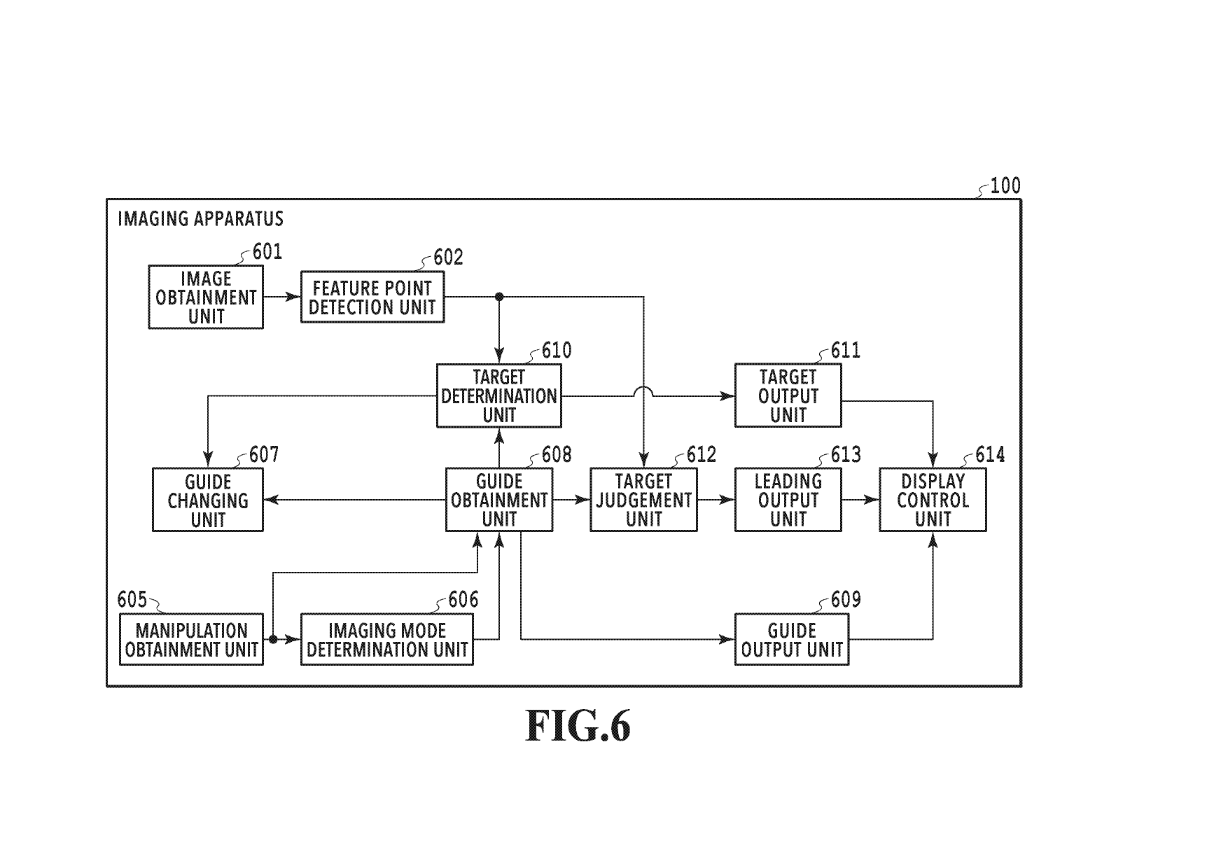

FIG. 6 is a block diagram illustrating an example of a functional configuration of the imaging apparatus 100 according to embodiment 1. As the functional configuration, the imaging apparatus 100 includes an image obtainment unit 601, a feature point detection unit 602, a manipulation obtainment unit 605, an imaging mode determination unit 606, a guide changing unit 607, a guide obtainment unit 608, and a guide output unit 609. Additionally, in addition to the above-described functional configuration, the imaging apparatus 100 includes a target determination unit 610, a target output unit 611, a target judgement unit 612, a leading output unit 613, and a display control unit 614. Note that, processing of each functional configuration illustrated in FIG. 6 is implemented with the CPU 501 deploying the program and the like stored in the ROM 502 and the like to the RAM 503 to execute.

The image obtainment unit 601 obtains the captured image obtained by imaging by the image capturing unit 505. The feature point detection unit 602 detects the feature point included in the captured image obtained by the image obtainment unit 601. For example, as a detection result of the feature point included in the captured image, the feature point detection unit 602 obtains an estimation result of a skeleton position, which is obtained by inputting the captured image to a learned skeleton estimation model obtained as a result of learning such as deep learning. The detection processing of the feature point included in the captured image performed by the feature point detection unit 602 is not limited to the above-described method, and the position of the representation of an object in the captured image that is detected by object detection processing and the like may be the feature point. Feature point information indicating the detection result of the feature point obtained by the feature point detection unit 602 is stored in the storage device 504, for example.

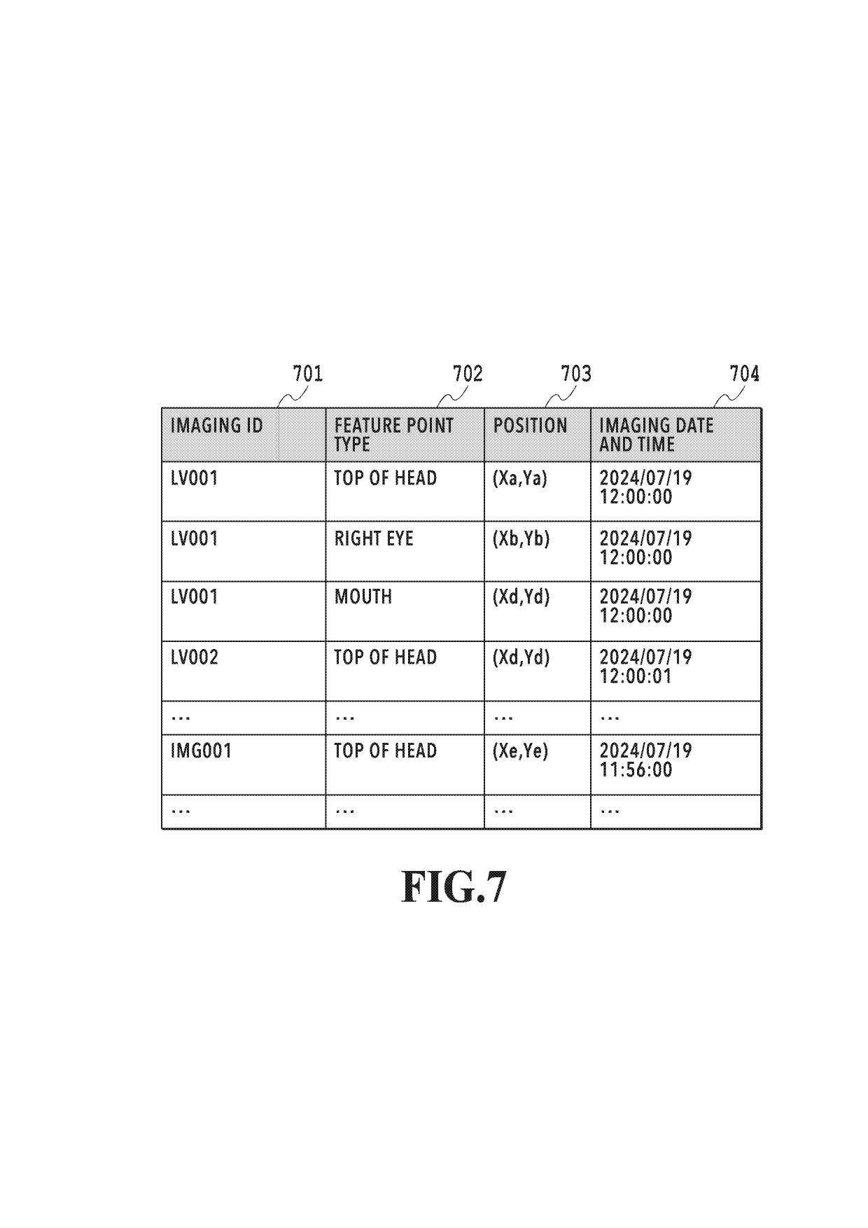

FIG. 7 is a diagram illustrating an example of the feature point information according to embodiment 1. The feature point information illustrated in FIG. 7 includes each item column of imaging ID 701, feature point type 702, position 703, and imaging date and time 704. In the imaging ID 701, an identifier (ID) to uniquely identify imaging is saved as an item value. The ID is information that may uniquely specify the imaging, in which the captured image is obtained, from which the feature point is detected. A unique ID is allocated for each imaging. Hereinafter, as an example, it is described assuming that "LV" + "arbitrary triple-digit number" is allocated for each imaging in a case of imaging of the live view, and "IMG" + "arbitrary triple-digit number" is allocated for each imaging in a case of imaging of the still image, respectively.

In the feature point type 702, information indicating a type of the feature point detected in the captured image is saved as the item value. Hereinafter, as an example, it is described assuming that a name of a predetermined part obtained as the estimation result using the skeleton estimation model is saved as the information indicating the type of the feature point. In the position 703, information indicating the position of each feature point in the captured image that is obtained as the estimation result using the skeleton estimation model is saved as the item value. Hereinafter, as an example, it is described assuming that the position of the feature point in the captured image is represented by using a coordinate system including two axes in a vertical direction (a Y axis) and a horizontal direction (an X axis) in which the origin is the upper left of the captured image. In the imaging date and time 704, information indicating an imaging date and time of the captured image at which the feature point is detected is saved as the item value.

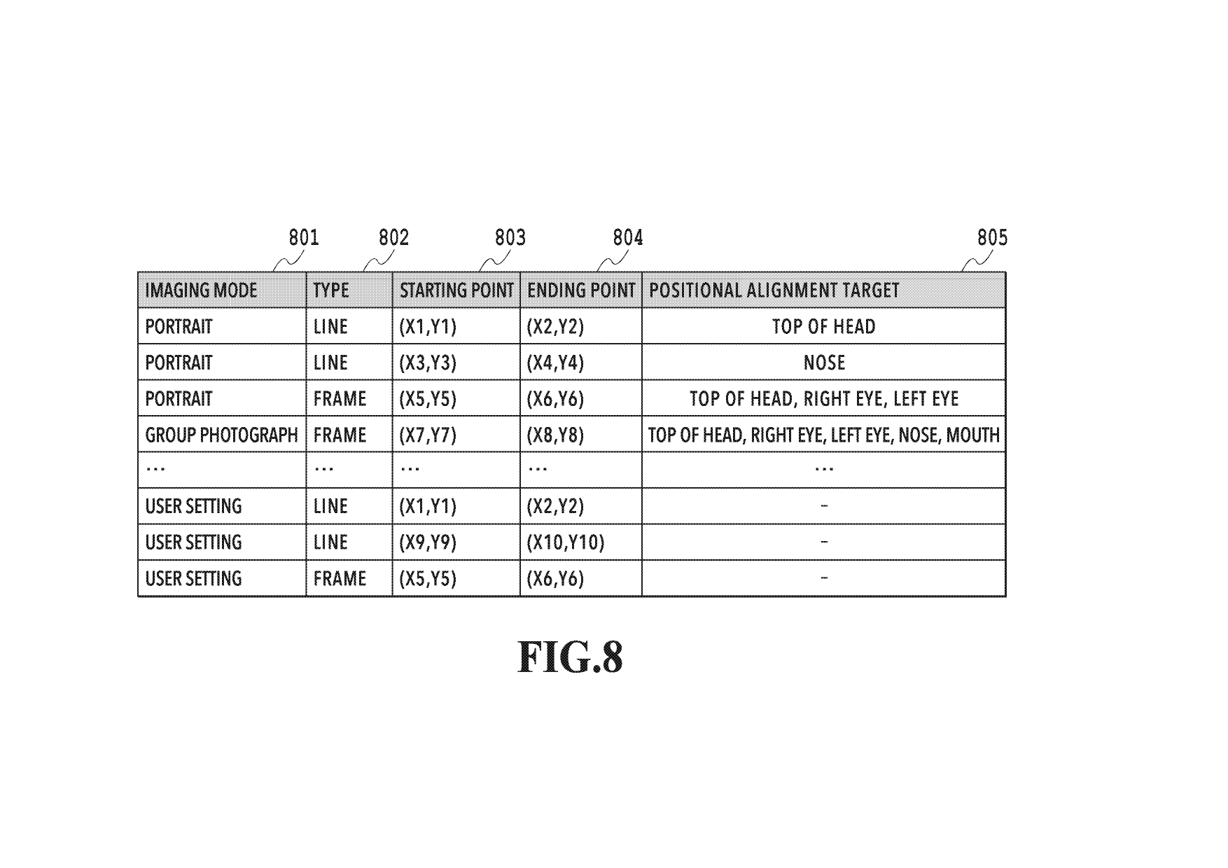

FIG. 8 is a diagram illustrating an example of guide information according to embodiment 1. The guide information created by the photographer 101 in S201 is described with reference to FIG. 8. The guide information illustrated in FIG. 8 includes each item column of imaging mode 801, type 802, starting point 803, ending point 804, and positional alignment target 805. In the imaging mode 801, information on an imaging mode in which the guide is used is saved as the item value. The imaging mode is set by the photographer 101, and the photographer 101 sets the imaging mode by switching the imaging mode depending on the composition or the scene of imaging. Once the photographer 101 changes the imaging mode, the guide displayed on the display device 507 is changed. In the type 802, information on a type related to the shape of the guide is saved as the item value. The type related to the shape of the guide includes "line" and "frame," for example.

In the starting point 803 and the ending point 804, information related to a display position of the guide on the display screen in a case where the guide is displayed on the display device 507 is saved as the item value. For example, in a case where the item value of the type 802 is "line," a line segment connecting the starting point and the ending point is displayed on the display device 507 as the guide. Additionally, in a case where the item value of the type 802 is "frame," the starting point represents a position of the upper left of a rectangle displayed as the guide on the display screen in the display device 507, while the ending point represents a position of the lower right of the rectangle.

In the positional alignment target 805, information indicating the name of the part corresponding to the feature point as a target of positional alignment with each guide is saved as the item value. Note that, the item value saved in each item column of the imaging mode 801, the type 802, the starting point 803, and the ending point 804 is inputted in a case of being created by the photographer 101 in S201. On the other hand, the item value saved in the item column of the positional alignment target 805 is inputted during the saving processing in S207. Additionally, as with the item value saved as the feature point type 702 illustrated in FIG. 7, as the positional alignment target 805, the name of the predetermined part obtained as the estimation result using the skeleton estimation model is saved as the information indicating the type of the feature point.

The manipulation obtainment unit 605 obtains manipulation information corresponding to manipulation by the photographer 101 accepted by the input unit 508. The imaging mode determination unit 606 determines the imaging mode by selecting the imaging mode set by the photographer 101 based on the manipulation information obtained by the manipulation obtainment unit 605. The guide obtainment unit 608 obtains the information related to the guide corresponding to the imaging mode determined by the imaging mode determination unit 606 out of the pieces of the guide information corresponding to the imaging modes. The guide output unit 609 generates the guide indicated by the information related to the guide obtained by the guide obtainment unit 608 as a GUI component, for example, and outputs the generated GUI component to the display control unit 614.

The target determination unit 610 executes the processing in S206 in the workflow illustrated in FIG. 2A and 2B. Specifically, based on the positional relationship between the feature point indicated by the feature point information that is the detection result obtained by the feature point detection unit 602 and the guide obtained by the guide obtainment unit 608, the target determination unit 610 determines the type of the feature point as the target of positional alignment with each guide. Based on the type of the feature point as the target of positional alignment determined by the target determination unit 610, the guide changing unit 607 changes the information related to the guide corresponding to the imaging mode determined by the imaging mode determination unit 606. The target output unit 611 generates the GUI component indicating the position of the feature point as the target determined by the target determination unit 610 and outputs the generated GUI component to the display control unit 614.

The target judgement unit 612 executes the processing in S209 in the workflow illustrated in FIG. 2A and 2B. Specifically, the target judgement unit 612 judges whether the positional relationship between the guide indicated by the information related to the guide obtained by the guide obtainment unit 608 and the feature point indicated by the feature point information that is the detection result obtained by the feature point detection unit 602 is proper. Details of the judgement processing by the target judgement unit 612 are described later. The leading output unit 613 executes the processing in S208 in the workflow illustrated in FIG. 2A and 2B. Specifically, if the target judgement unit 612 judges that the positional relationship between the guide and the feature point is improper, the leading output unit 613 generates the leading information and outputs the generated leading information to the display control unit 614. The display control unit 614 performs output control to display the GUI component related to the guide, the GUI component indicating the position of the feature point as the target, and the leading information generated by the guide output unit 609, the target determination unit 610, and the leading output unit 613, respectively, on the display device 507.

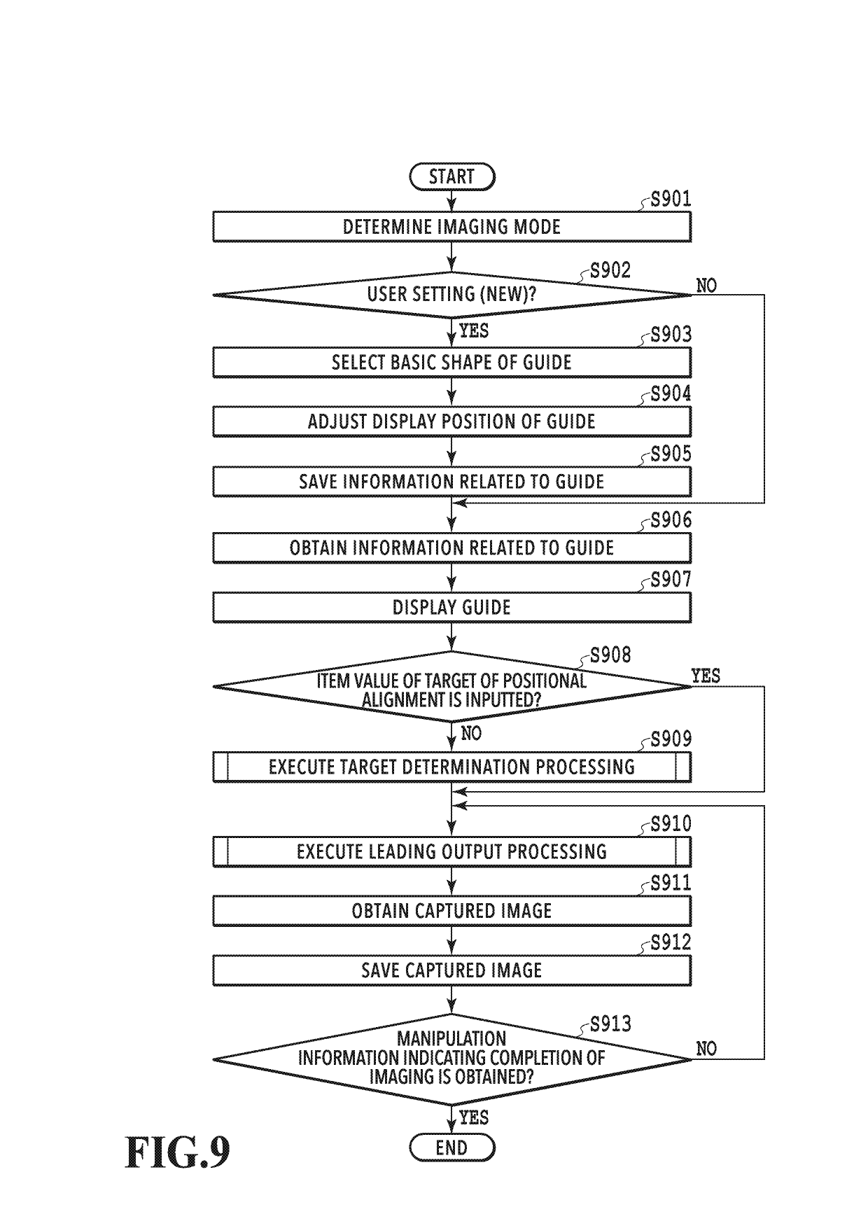

FIG. 9 is a flowchart illustrating an example of a flow of the processing by the imaging apparatus 100 according to embodiment 1. Each processing step in the flowchart described below is described by using a reference sign starting with "S." Note that, each processing step in the flowchart described below is implemented with the CPU 501 deploying the program and the like stored in the ROM 502 and the like to the RAM 503 to execute. First, in S901, the imaging mode determination unit 606 determines the imaging mode by selecting the imaging mode set by the photographer 101 based on the manipulation information obtained by the manipulation obtainment unit 605.

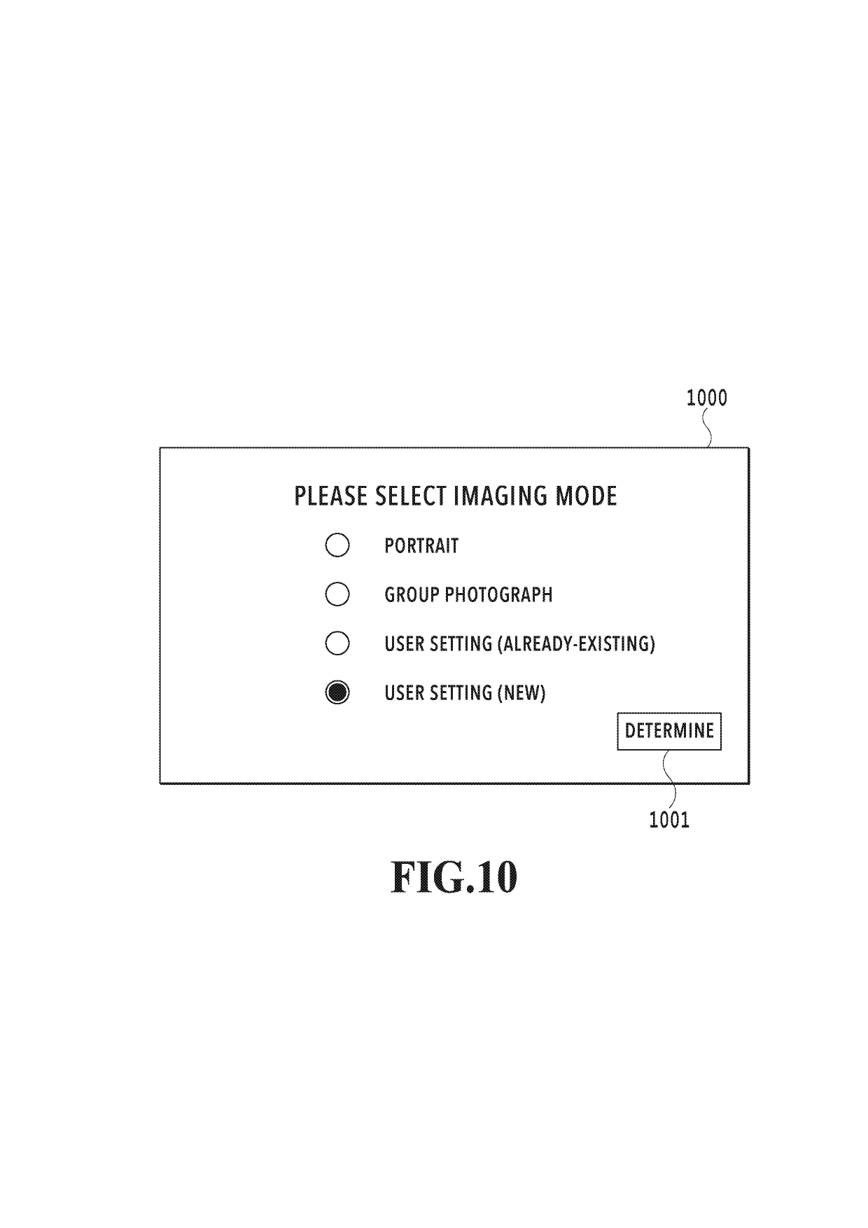

FIG. 10 is a diagram illustrating an example of an imaging mode selection screen 1000 according to embodiment 1. For example, the imaging mode selection screen 1000 is displayed on the display device 507 and displayed by control performed by the display control unit 614 based on manipulation by the photographer 101. The photographer 101 selects one of multiple items displayed on the imaging mode selection screen 1000 and then presses a determination button 1001. In a case where the determination button 1001 is pressed, the manipulation obtainment unit 605 obtains the manipulation information corresponding to the item selected by the photographer 101. Thereafter, the imaging mode determination unit 606 determines the imaging mode based on the manipulation information obtained by the manipulation obtainment unit 605. Hereinafter, it is described assuming that "portrait," "group photograph," "user setting (already-existing)," and "user setting (new)" exist as the items that the photographer 101 may select as the imaging mode on the imaging mode selection screen 1000.

"Portrait" and "group photograph" are the imaging modes in which the guide set in advance in the imaging apparatus 100 at a factory and the like is displayed during displaying of the live view in a case of imaging. "User setting (new) mode" is the imaging mode selected in a case where the photographer 101 wants to create the own guide. In a case where the determination button 1001 is pressed in a state in which "user setting (new)" is being selected, the photographer 101 creates the guide described later, and the information related to the guide newly created by the photographer 101 is added to the guide information. "User setting (already-existing) mode" is the imaging mode in which the guide indicated by the information related to the guide that is already created in "user setting (new) mode" and already saved as the guide information is displayed during displaying of the live view in a case of imaging. In a case where there is no information related to the guide created by the user exists as the guide information, the item of "user setting (already-existing)" may be prevented from being selected on the imaging mode selection screen 1000 and may be hidden.

After S901, in S902, the guide obtainment unit 608 judges whether the imaging mode determined in S901 is "user setting (new)". If it is judged in S902 that it is not "user setting (new)," the imaging apparatus 100 executes processing in S906 described later. If it is judged in S902 that it is "user setting (new)," in S903, the guide obtainment unit 608 obtains the information related to the guide having a basic shape that is used to create the guide unique to the user. Specifically, for example, the photographer 101 selects the guide having the desired basic shape from multiple guides having the basic shape, and the guide obtainment unit 608 obtains the information related to the guide having the basic shape selected by the photographer 101.

After S903, in S904, the guide changing unit 607 changes the display position of the guide having the basic shape selected by the photographer 101 in S903. Specifically, for example, the guide having the basic shape selected in S903 is displayed on the display device 507, and the photographer 101 adjusts the display position of the guide while confirming the displayed guide. The guide changing unit 607 changes the information related to the guide based on the adjusted content of the display position of the guide by the photographer 101. After S904, in S905, the guide changing unit 607 adds the changed information related to the guide to the guide information and saves the guide information.

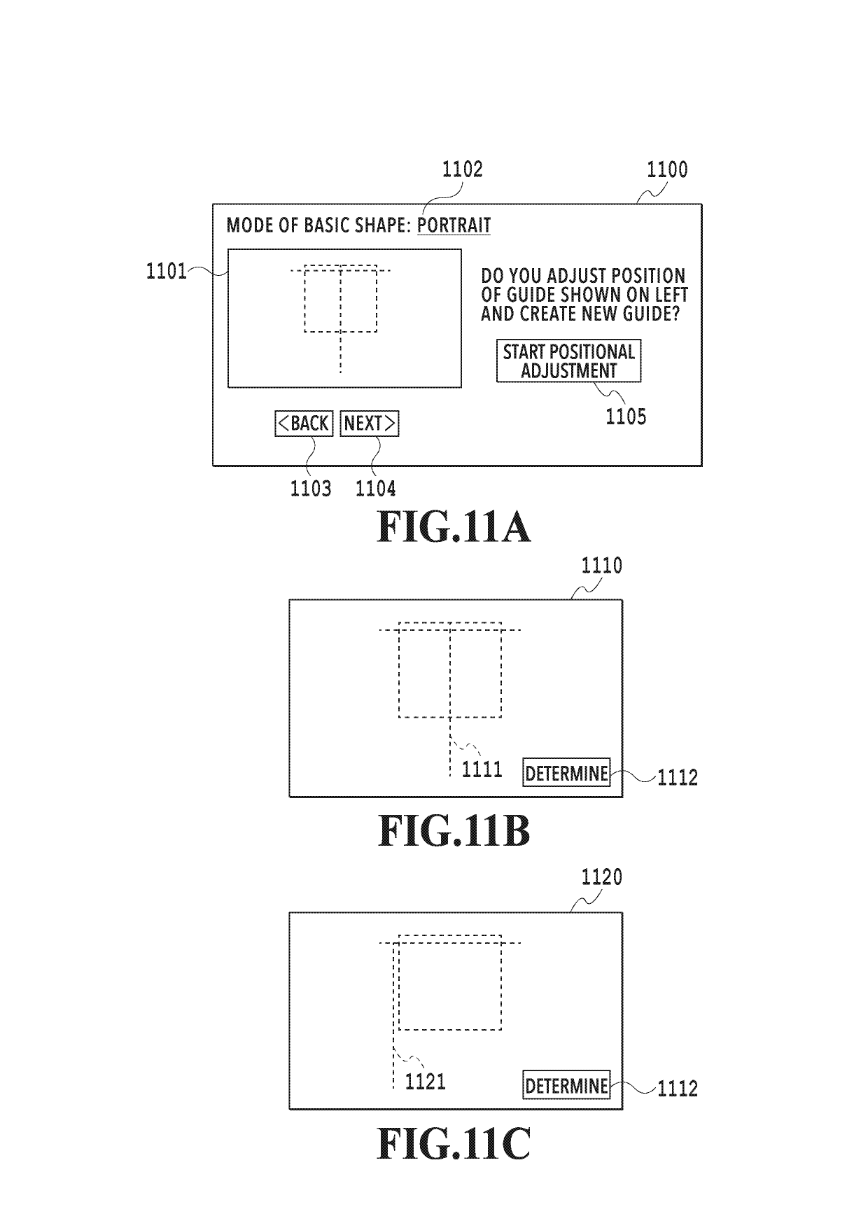

FIG. 11A is a diagram illustrating an example of a guide selection screen 1100 to select the basic shape of the guide according to embodiment 1, and FIGS. 11B and 11C are diagrams illustrating an example of adjustment screens 1110 and 1120 to adjust the display position of the guide. The guide selection screen 1100 includes a guide display region 1101, a mode display region 1102, selection buttons 1103 and 1104, and a start button 1105, as an example.

In the guide display region 1101, the basic shape of the guide held in advance by the imaging apparatus 100 is displayed. For example, the guide display region 1101 has an aspect ratio comparable to an aspect ratio of the display screen on the display device 507, the image sensor in the image capturing unit 505, or the captured image. In the mode display region 1102, a name of the imaging mode in which the basic shape being displayed in the guide display region 1101 may be used is displayed.

The selection buttons 1103 and 1104 are buttons to change a form of the basic shape of the guide displayed in the guide display region 1101. In a case where the selection button 1103 or 1104 is pressed by the photographer 101, the basic shape of the guide displayed in the guide display region 1101 is switched. Additionally, in this case, the name of the imaging mode displayed in the mode display region 1102 is switched depending on the basic shape of the guide displayed in the guide display region 1101. For example, in a case where the selection button 1104 is pressed, the basic shape of the guide displayed in the guide display region 1101 is switched to a shape for "group photograph," and accordingly, the name of the imaging mode displayed in the mode display region 1102 is switched from "portrait" to "group photograph." The start button 1105 is a button that is pressed after selection of the basic shape of the guide is completed, and in a case where the start button 1105 is pressed, the display screen displayed on the display device 507 transitions from the guide selection screen 1100 to the adjustment screen 1110.

The adjustment screen 1110 illustrated in FIG. 11B displays a guide 1111 having the basic shape before adjusting the display position that is obtained in S903. Additionally, the adjustment screen 1120 illustrated in FIG. 11C displays a guide 1121 after adjusting the display position in S904. Additionally, the adjustment screens 1110 and 1120 each display a determination button 1112. The photographer 101 selects the guide displayed on the adjustment screen 1110 and the like by performing touch manipulation using the touch panel or pressing of the button switch and the like, for example, and adjusts the position of the guide.

The determination button 1112 is a button to save the information related to the guide after adjusting the display position. In a case where the determination button 1112 is pressed, the shape of the guide based on the user setting is determined, and the determined information related to the guide is saved in the guide information. Note that, in a case where the information related to the guide that is created by the photographer 101 already exists in the guide information, for example, after removing the information from the guide information, the imaging apparatus 100 may add the newly created information related to the guide to the guide information. In this case, in a timing in which the newly created information related to the guide is saved, the type of the feature point as the target of positional alignment with the guide is not determined yet. Therefore, at a time point of creating and saving the new guide, no item value of the positional alignment target 805 in the guide information is inputted.

After S905, in S906, the guide obtainment unit 608 obtains the information related to the guide corresponding to the imaging mode determined in S901 by reading out from the guide information. Note that, if it is judged in S902 that the imaging mode is "user setting (new)," the guide obtainment unit 608 obtains the information related to the guide saved in S905 by reading out from the guide information. Next, in S907, the guide is displayed on the display device 507 based on the information related to the guide obtained in S906.

Specifically, first, the guide output unit 609 generates the guide as the GUI component based on the information related to the guide obtained in S906 and outputs the generated GUI component to the display control unit 614. Subsequently, the display control unit 614 performs output control of the GUI component related to the guide that is generated by the guide output unit 609 and displays the guide on the display device 507. Note that, the display control unit 614 performs output control of the live view on the display device 507 and displays the guide on the display device 507 so as to superimpose the guide on the live view.

After S907, in S908, the target judgement unit 612 judges whether the item value of the positional alignment target 805 is included in the information related to the guide obtained in S906. If it is judged in S908 that the item value of the positional alignment target 805 is not included, the imaging apparatus 100 executes processing in S909, and if it is judged in S908 that the item value is included, the imaging apparatus 100 executes processing in S910. Hereinafter, in the present embodiment, it is described assuming that the item value of the positional alignment target 805 corresponding to the imaging mode other than "user setting (new)" is inputted; however, it is not limited thereto. For example, the item value of the positional alignment target 805 corresponding to all the imaging modes may not be inputted, the type of the feature point as the target of positional alignment with the guide may be determined in the processing in S909 described later.

In S909, the imaging apparatus 100 executes determination processing about the type of the feature point as the target of positional alignment with the guide displayed in S907 (hereinafter, referred to as "target determination processing"). Details of the target determination processing in S909 are described later. After S909, the imaging apparatus 100 executes the processing in S910. In S910, the imaging apparatus 100 executes the output processing of the leading information as illustrated in FIG. 4 (hereinafter, referred to as "leading output processing") according to the positional relationship between the guide displayed in S907 and the representation of the person as the subject. Details of the leading output processing in S910 are described later.

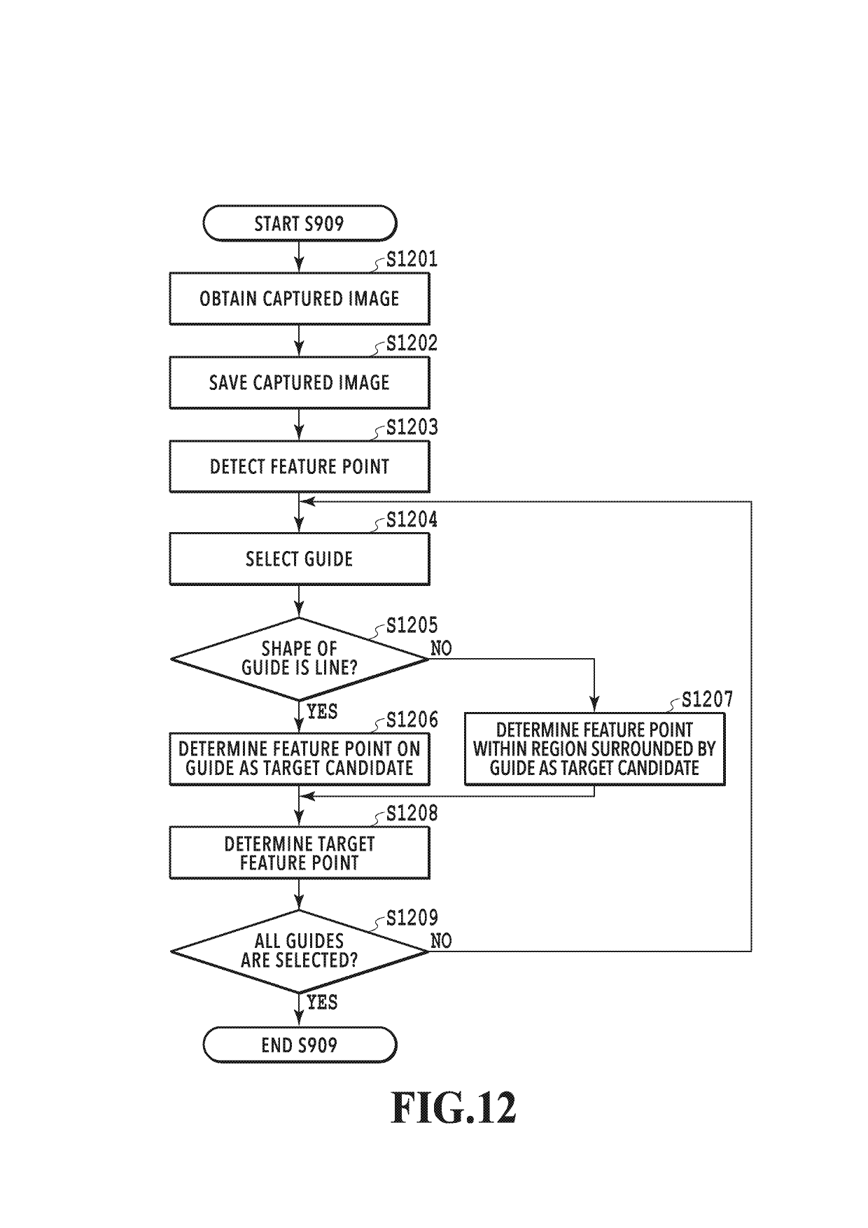

FIG. 12 is a flowchart illustrating an example of a detailed processing flow of target determination processing by the imaging apparatus 100 according to embodiment 1, in other words, the processing in S909 in the flowchart illustrated in FIG. 9. First, in S1201, the image obtainment unit 601 obtains data on the captured image obtained with the photographer 101 performing imaging. Specifically, first, the photographer 101 changes at least one of the position and the posture of the person and the position and the posture of the imaging apparatus 100 to obtain the proper imaging composition with reference to the guide displayed in S907. Subsequently, in a case where the proper imaging composition is obtained, the photographer 101 performs imaging of the person by manipulation such as pressing the shutter button. Next, in S1202, the image obtainment unit 601 saves the data on the captured image obtained in S1201 into the storage device 504 and the like.

Next, in S1203, the feature point detection unit 602 detects the feature points included in the captured image obtained in S1201 and saves the detection result as the feature point information. In S1204, the target determination unit 610 selects an arbitrary guide from one or more guides displayed in S907. Next, in S1205, the target determination unit 610 judges whether the type of the guide selected in S1204 is "line." If it is judged in S1205 that the type is "line," the imaging apparatus 100 executes the processing in S1206, and if it is judged that the type is not "line" (in the present embodiment, if it is judged as "frame"), the imaging apparatus 100 executes processing in S1207. In S1206, out of the feature points detected in S1203, the target determination unit 610 determines the feature point existing on the guide (also including approximately on the guide) having the linear shape that is selected in S1204 as a candidate of the feature point as the target of positional alignment (hereinafter, referred to as a "target feature point"). Hereinafter, the candidate of the target feature point is referred to as a "target candidate". In S1207, out of the feature points detected in S1203, the target determination unit 610 determines the feature point existing within the frame of the guide having the frame shape that is selected in S1204 as the target candidate.

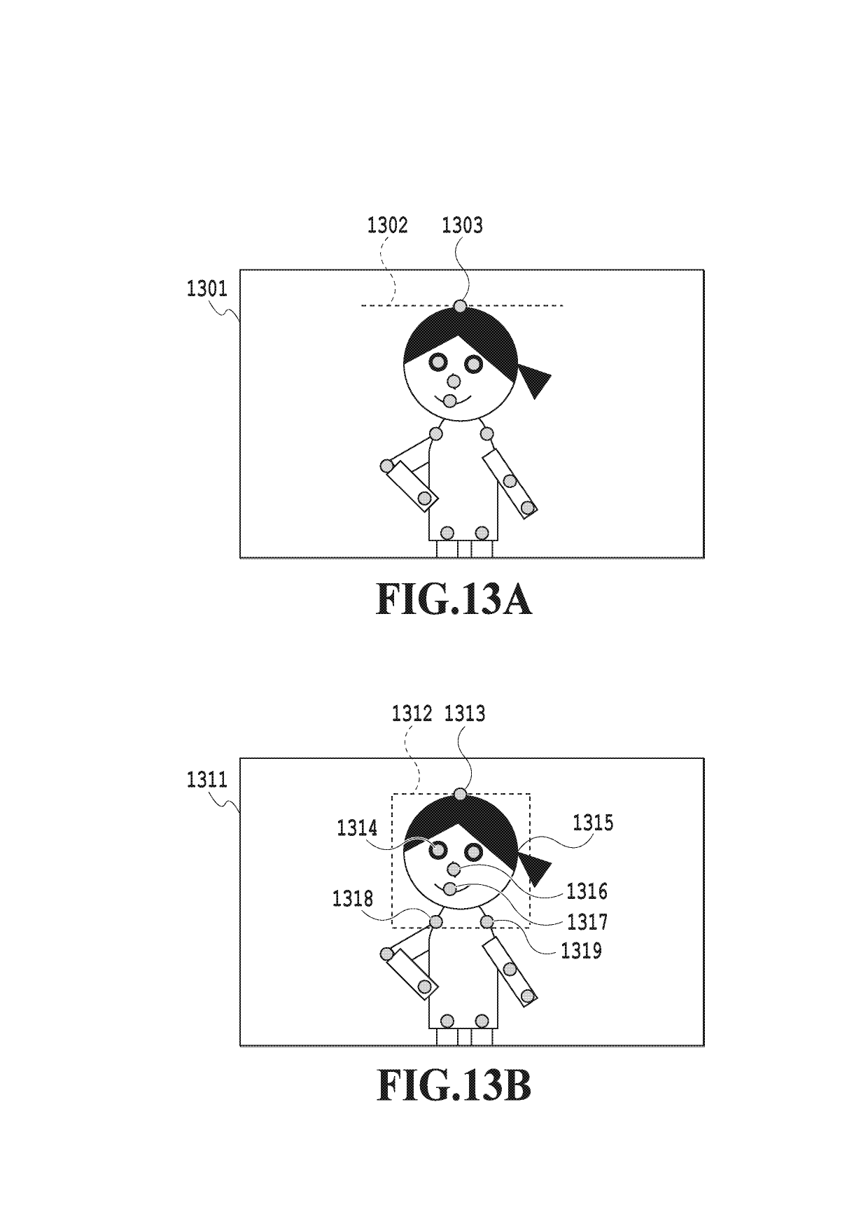

FIGS. 13A and 13B are diagrams describing an example of the target determination processing by the target determination unit 610 according to embodiment 1. Specifically, FIG. 13A is a diagram describing an example of the determination processing of the target candidate in a case where the type of the guide is "line." FIG. 13B is described later. An image 1301 is obtained by superimposing the guide selected in S1204 and the feature points detected in S1203 on the captured image obtained in S1201. A broken line 1302 is the guide selected in S1204. A circle 1303 is the feature point corresponding to the top of the head. In the example in FIG. 13A, the feature point of the top of the head indicated by the circle 1303 exists on the guide indicated by the broken line 1302. Therefore, the target determination unit 610 determines that the type of the target candidate of positional alignment with the guide indicated by the broken line 1302 is the top of the head.

FIG. 13B is a diagram describing an example of the determination processing of the target feature point in a case where the type of the guide is "frame." An image 1311 is obtained by superimposing the guide selected in S1204 and the feature points detected in S1203 on the captured image obtained in S1201. A broken line 1312 is the guide selected in S1204. A circle 1313 is the feature point corresponding to the top of the head. A circle 1314 is the feature point corresponding to a right eye. The circle 1315 is the feature point corresponding to a left eye. A circle 1316 is the feature point corresponding to a nose. A circle 1317 is the feature point corresponding to a mouth. A circle 1318 is the feature point corresponding to a right shoulder. A circle 1319 is the feature point corresponding to a left shoulder. In the example in FIG. 13B, the feature point corresponding to each of the circles 1313 to 1319 is included within the frame of the guide indicated by the broken line 1312. Therefore, the target determination unit 610 determines that the type of the target candidate of positional alignment with the guide indicated by the broken line 1312 is the top of the head, the right eye, the left eye, the nose, the mouth, the right shoulder, and the left shoulder.

After S1206 or S1207, in S1208, out of one or more target candidates determined in S1206 or S1207, the target determination unit 610 determines the target feature point based on manipulation by the photographer 101. Specifically, the imaging apparatus 100 displays a selection screen to select the target candidate on the display device 507 via the target output unit 611 and the display control unit 614. Out of the one or more target candidates displayed on the selection screen displayed on the display device 507, the photographer 101 selects desired one or more target candidates by using the input unit 508. The target determination unit 610 determines the target feature point based on the manipulation information related to the selection of the target candidate by the photographer 101 that is obtained via the manipulation obtainment unit 605.

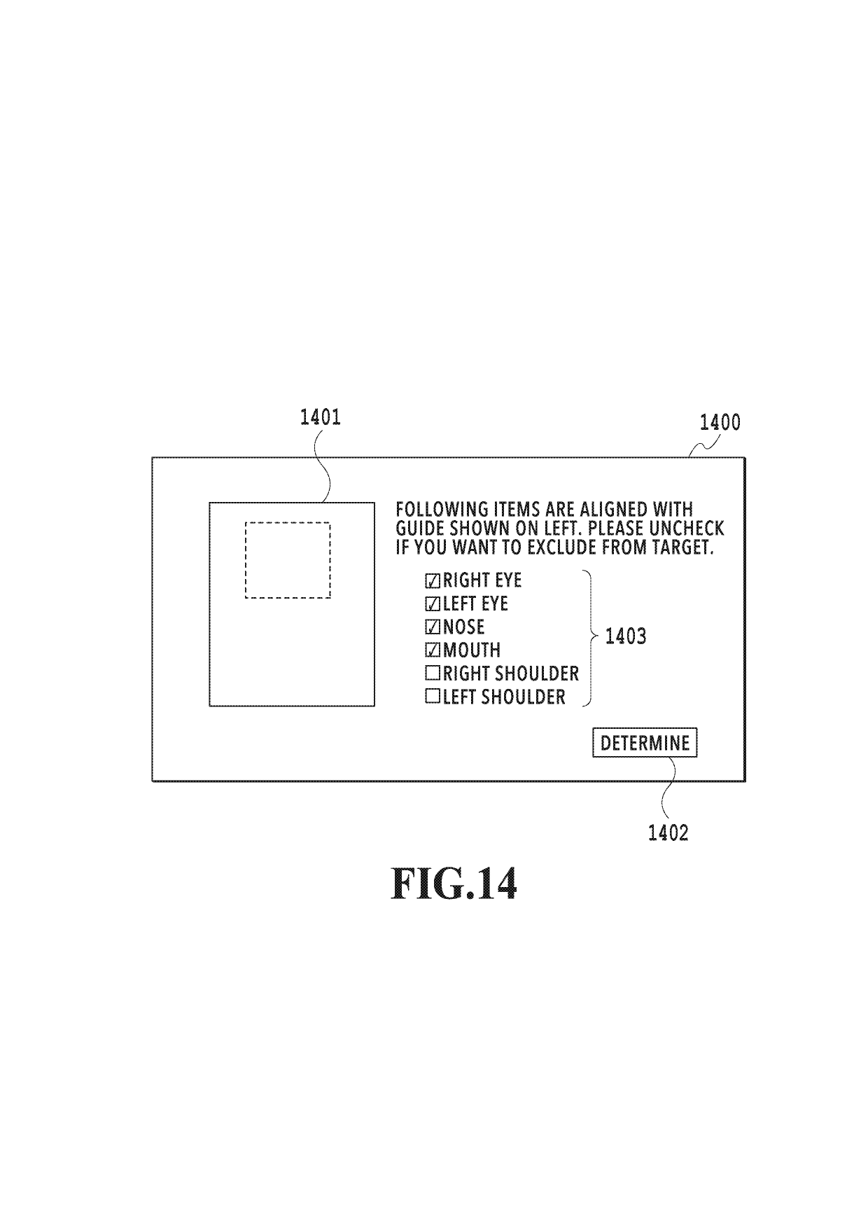

FIG. 14 is a diagram illustrating an example of the selection screen of the target candidate according to embodiment 1. A selection screen 1400 includes a guide display region 1401, a candidate selection region 1403, and a determination button 1402. The guide display region 1401 is a region in which the guide selected in S1204 is displayed. In the candidate selection region 1403, a list of the target candidates for the guide displayed in the guide display region 1401 are displayed as a list of checkboxes. Out of the one or more target candidates displayed in the guide display region 1401, the photographer 101 checks the target candidate that the photographer 101 wants to use as the target feature point, and the photographer 101 unchecks the target candidate that the photographer 101 does not want to use as the target feature point; accordingly, the target candidate to be used as the target feature point is selected from the target candidates.

After the target candidate to be used as the target feature point is selected, the photographer 101 presses the determination button 1402. In a case where the determination button 1402 is pressed by the photographer 101, the target determination unit 610 sets the target candidate checked on the selection screen 1400 as the target feature point and saves the information related to the type of the target feature point. Specifically, the target determination unit 610 saves the information related to the type of the target candidate checked on the selection screen 1400 in the column of the positional alignment target 805 in the information corresponding to the guide selected in S1204.

After S1208, in S1209, the target determination unit 610 judges whether all the guides are selected in S1204. If it is judged in S1209 that at least one guide is not selected, the target determination unit 610 returns to S1204 and repeatedly executes the processing from S1204 to S1209 until it is judged in S1209 that all the guides are selected. In the repeated processing, in S1204, the target determination unit 610 selects an arbitrary guide that is not selected yet. If it is judged in S1209 that all the guides are selected, the imaging apparatus 100 ends the processing of the flowchart illustrated in FIG. 12, in other words, the processing in S909 illustrated in FIG. 9.

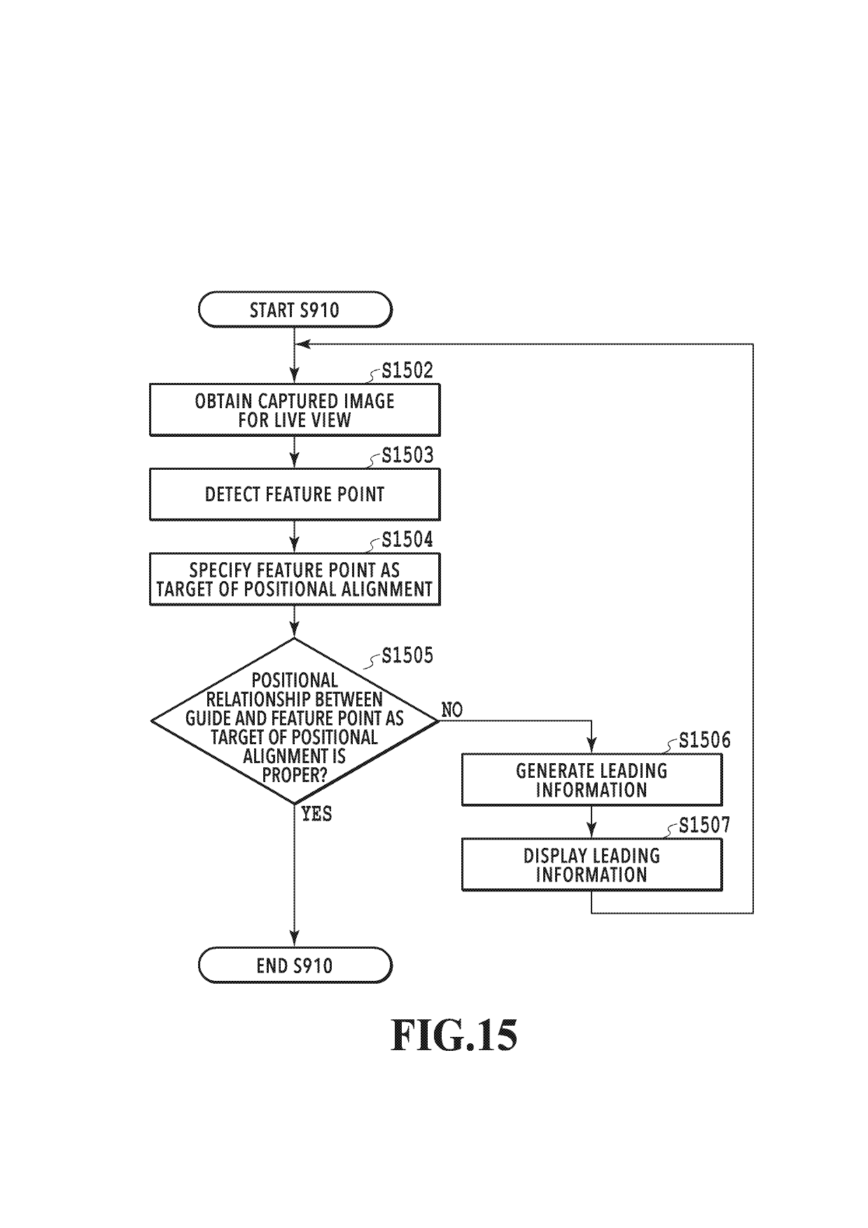

FIG. 15 is a flowchart illustrating an example of a detailed processing flow of the leading output processing by the imaging apparatus 100 according to embodiment 1, in other words, the processing in S910 in the flowchart illustrated in FIG. 9. First, in S1502, the imaging apparatus 100 performs live view imaging, and the image obtainment unit 601 obtains the captured image obtained by the live view imaging (hereinafter, referred to as a "live view image"). Next, in S1503, the feature point detection unit 602 detects the feature point included in the live view image obtained in S1502 and saves the detection result as the feature point information. Next, in S1504, the target judgement unit 612 specifies the target feature point out of the one or more feature points detected in S1503 by using the value in the column of the positional alignment target 805 in the information related to the guide obtained in S906.

Next, in S1505, the target judgement unit 612 judges whether the positional relationship between the guide and the target feature point specified in S1504 is proper based on the information related to the guide obtained in S906. A state in which the positional relationship is proper in a case where the type of the guide is a line is a case where the target feature point exists on the guide (also including substantially on the guide). Additionally, a state in which the positional relationship is proper in a case where the type of the guide is a frame is a case where the target feature point exists within the frame of the guide. If it is judged in S1505 that it is an improper state, in S1506, the leading output unit 613 generates and outputs the leading information indicating that the position of the target feature point is displaced from the guide. The leading information outputted from the leading output unit 613 is notified to the photographer 101 by being displayed on the display device 507 via the display control unit 614. An example of the notification method is illustrated in FIG. 4; for this reason, the description is omitted.

Thereafter, the photographer 101 changes the position or the posture of the imaging apparatus 100 or changes the position or the posture of the person as the subject so as to obtain the proper state of the position of the target feature point with respect to the guide while confirming the notification. Additionally, until it is judged in S1505 that it is the proper state, the imaging apparatus 100 repeatedly executes the processing from S1502 to S1506. If it is judged in S1505 that it is the proper state, the imaging apparatus 100 ends the processing of the flowchart illustrated in FIG. 15, in other words, ends the processing in S910. Note that, in the present embodiment, although it is described that the leading information is displayed on the display device 507 only in a case where the position of the target feature point is displaced from the guide, in other words, only in a case where the position of the target feature point with respect to the guide is improper, it is not limited thereto. For example, in a case where the position of the target feature point with respect to the guide is proper, the imaging apparatus 100 may notify of the state in which the position of the target feature point with respect to the guide is proper by changing the color of the guide and the like.

After S910, in S911, the image obtainment unit 601 obtains the data on the captured image obtained with the photographer 101 performing imaging. Specifically, at the end of S910, the positional relationship between the guide and the target feature point is the proper state. Therefore, the photographer 101 can perform imaging in a state in which the positional relationship between the guide and the target feature point is proper. Next, in S912, the image obtainment unit 601 saves the data on the captured image obtained in S911 into the storage device 504 and the like.

Next, in S913, the manipulation obtainment unit 605 judges whether the manipulation information indicating ending of imaging is obtained. For example, the photographer 101 performs manipulation to end imaging in a case where imaging of all the persons as the subject to be imaged is completed. If it is judged in S913 that no manipulation information indicating ending of imaging is obtained, the imaging apparatus 100 returns to the processing in S910 and repeatedly executes the processing from S910 to S913 until it is judged in S913 that the manipulation information indicating ending of imaging is obtained. If it is judged in S913 that the manipulation information indicating ending of imaging is obtained, the imaging apparatus 100 ends the processing of the flowchart illustrated in FIG. 9.

According to the imaging apparatus 100 formed as describe above, in a case where displacement occurs in the positional relationship between the guide individually set by the photographer 101 and the subject, it is possible to output the leading information to correct the displacement. Therefore, the photographer 101 can perform imaging of each of the multiple subjects to be imaged in the similar composition by performing imaging while displaying the guide. Additionally, according to the imaging apparatus 100 formed as described above, the photographer 101 can individually set the type of the target feature point of positional alignment with the guide. Therefore, the photographer 101 can edit the guide to achieve a composition desired by the photographer 101. As a result, according to the imaging apparatus 100 formed as described above, it is possible to assist the photographer to perform imaging properly.

The present embodiment is described assuming that the photographer 101 creates the information related to the guide by the imaging apparatus 100; however, it is not limited thereto. For example, the photographer 101 may use information equipment such as a PC to create the information related to the guide and may allow the imaging apparatus 100 to read the created information related to the guide. Additionally, in the present embodiment, the aspect in which the leading information is outputted by using an arrow and the like visible by the photographer 101 is described; however, the leading information may be outputted by using a character string, a text, or the like. Moreover, in this case, the leading information may be outputted in an aspect such as sound audible to the photographer 101.

### Embodiment 2

In embodiment 1, an aspect in which imaging is performed while displaying the guides to allow the photographer 101 to determine the positional relationship between all the guides and the target feature points and create the information related to the guides is described. In a case of the aspect according to embodiment 1, the photographer 101 needs to actively perform a work related to the creation of the guide. In the present embodiment, an aspect in which the imaging apparatus 100 proposes adding of the guide to the photographer 101 based on the captured image is described.

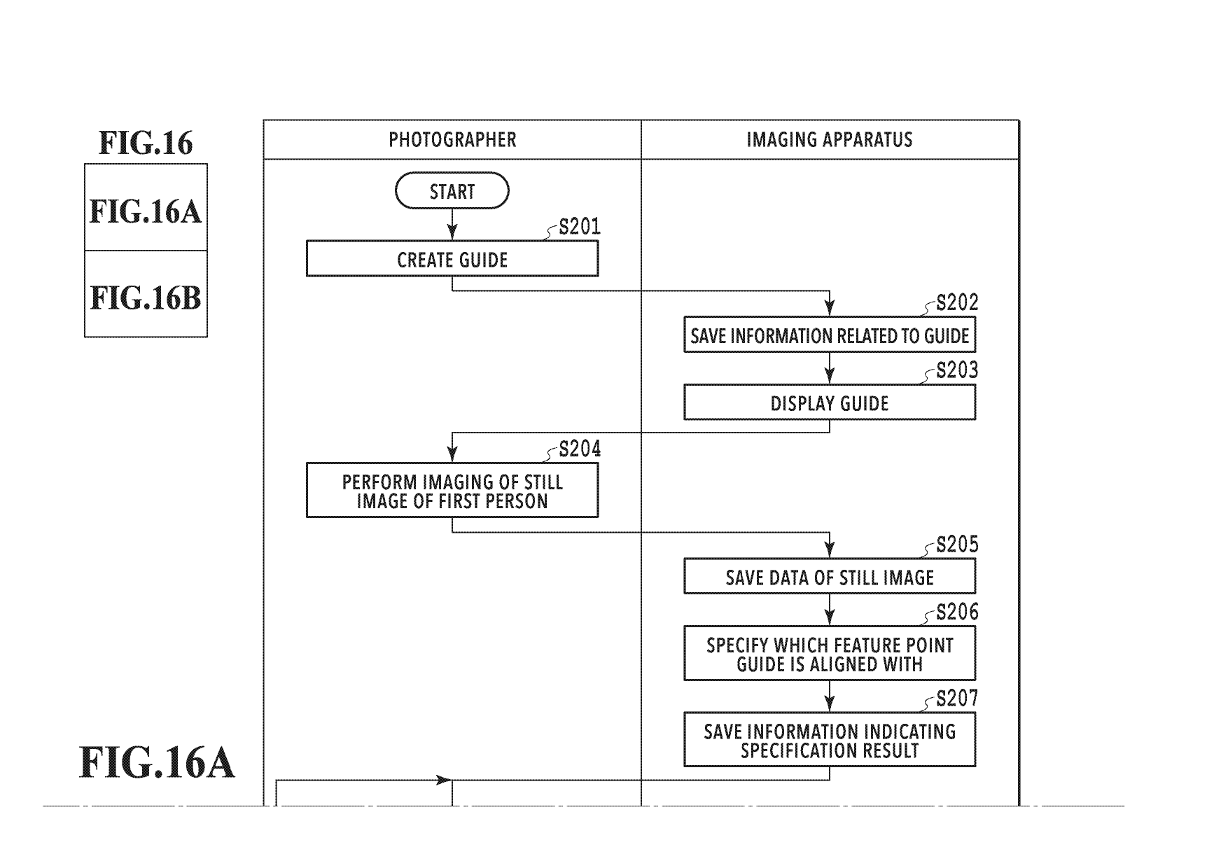

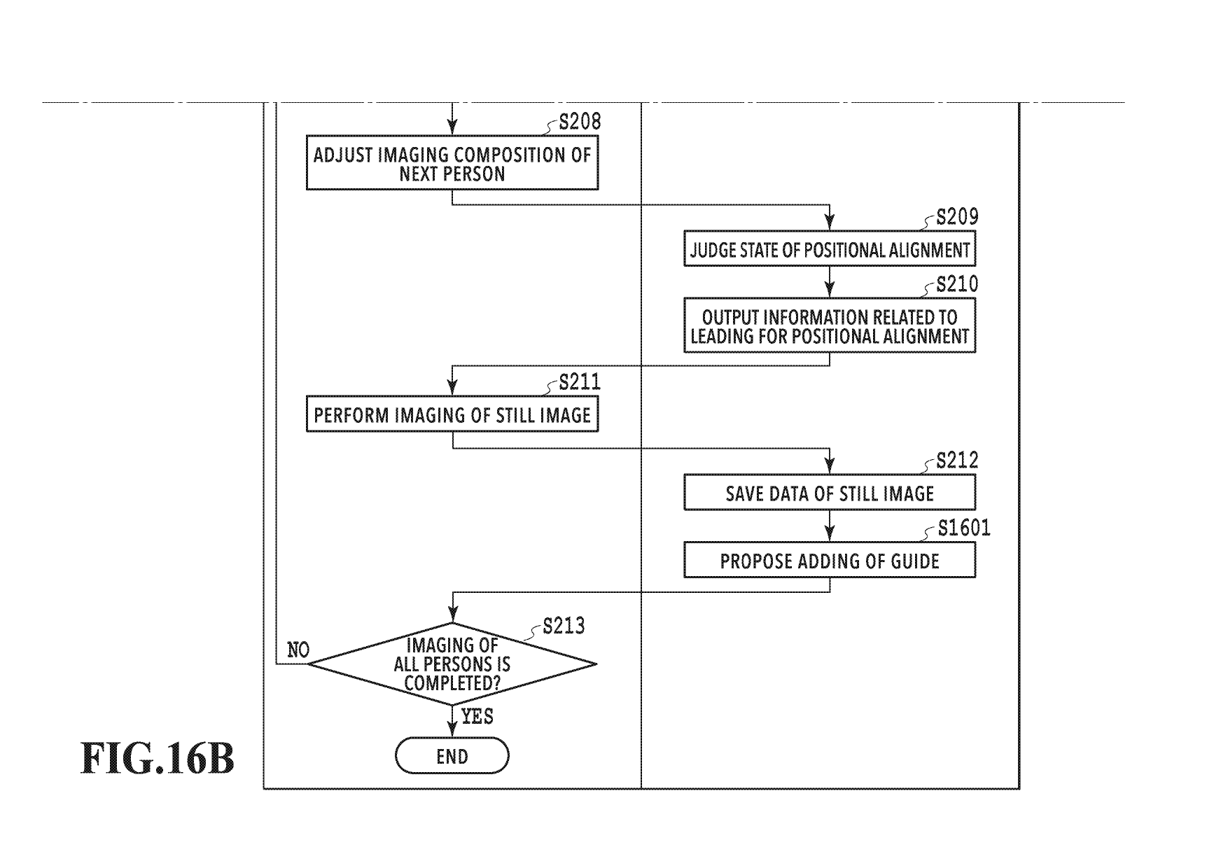

FIG. 16A and 16B is a diagram illustrating an example of a workflow in a use case according to an embodiment 2. In the description below, description of contents overlapping the description of the workflow illustrated in FIG. 2A and 2B is omitted by providing the same reference sign. After S212, in S1601, the imaging apparatus 100 displays an adding proposal screen to propose adding of the information related to the guide on the display device 507.

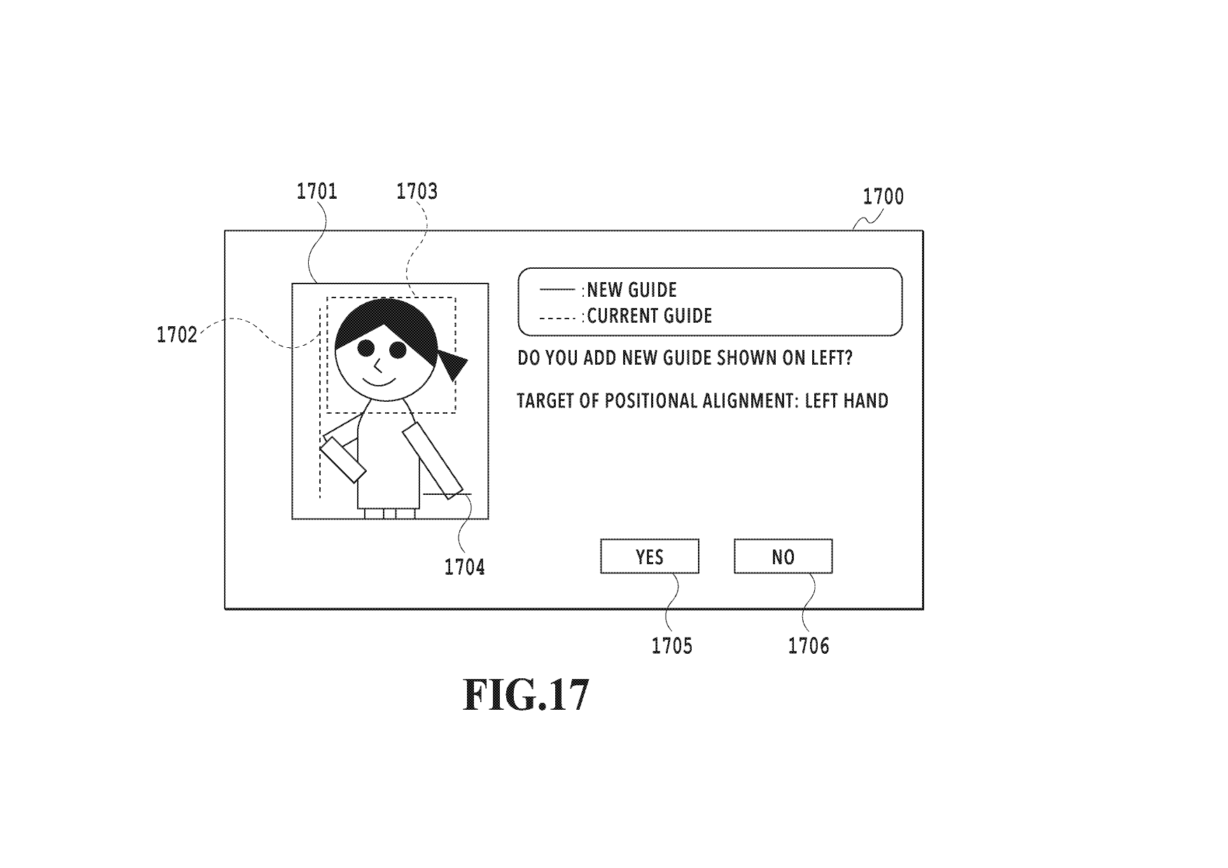

FIG. 17 is a diagram illustrating an example of an adding proposal screen 1700 according to embodiment 2. For example, the adding proposal screen 1700 includes a guide display region 1701 and buttons 1705 and 1706. For example, in S212, the adding proposal screen 1700 is displayed in a case where imaging is performed multiple number of times in the similar composition. In the guide display region 1701, the current guide already set and the new guide proposed to be added are displayed to be superimposed on the still image imaged and saved in S212 according to an instruction of imaging by the photographer 101 in S211. As an example, in the guide display region 1701 illustrated in FIG. 17, a case where imaging is performed multiple number of times in the composition as illustrated in FIG. 3A is illustrated. In the guide display region 1701, broken lines 1702 and 1703 indicate the current guide already set. Additionally, a solid line 1704 indicates the new guide proposed by the imaging apparatus 100 to be added.

For example, the new guide is generated and displayed in a position similar to the positions of the same type of the feature points in the captured images obtained through multiple number of times of imaging in the past. The adding proposal screen 1700 illustrated in FIG. 17 as an example is that in a case where the feature points of the type that is the left hand exist in the similar positions in the multiple captured images. In such a case, the imaging apparatus 100 judges that the photographer tries to perform imaging so as to set the position of the left hand in a predetermined position in the captured image, and the imaging apparatus 100 generates and proposes the new guide to align the position of the left hand with the predetermined position. Details of the method of generating the new guide are described later.

The button 1705 is a button that is pressed in a case where the photographer 101 accepts adding of the new guide. In a case where the button 1705 is pressed, the information related to the new guide displayed in the guide display region 1701 is added as the information related to the guide. The button 1706 is a button that is pressed in a case where the photographer 101 denies adding of the new guide. In a case where the button 1706 is pressed, for example, the imaging apparatus 100 ends displaying the adding proposal screen 1700 without adding the information related to the new guide as the information related to the guide.

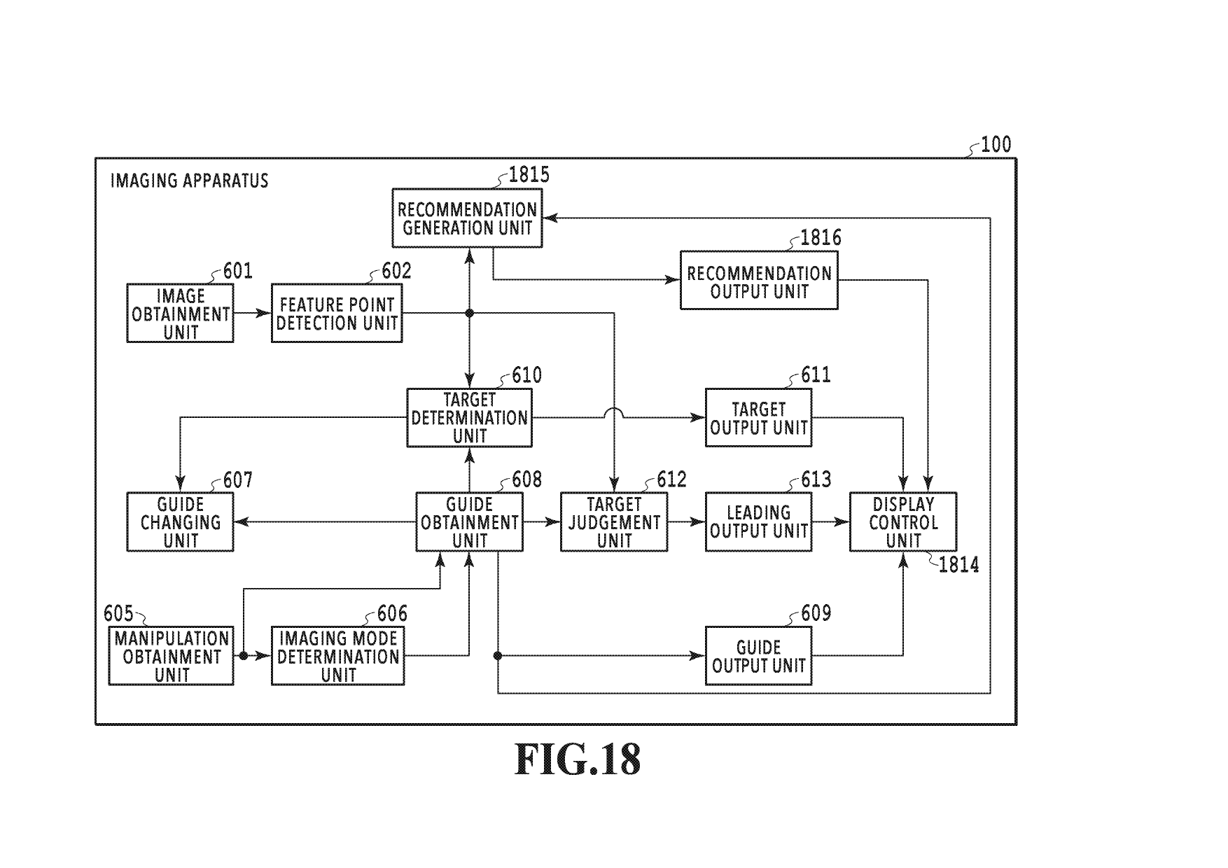

FIG. 18 is a block diagram illustrating an example of a functional configuration of the imaging apparatus 100 according to embodiment 2. In the description below, description of contents overlapping the description of the functional configuration illustrated in FIG. 6 is omitted by providing the same reference sign. Note that, processing of each functional configuration illustrated in FIG. 18 is implemented with the CPU 501 deploying the program and the like stored in the ROM 502 and the like to the RAM 503 to execute.

A recommendation generation unit 1815 generates the new guide based on the feature point information indicating the detection result of the feature point obtained by the feature point detection unit 602 and the information related to the guide obtained by the guide obtainment unit 608. Specifically, first, the recommendation generation unit 1815 judges whether the same type of the feature points exist in similar positions in the captured images through multiple number of times of imaging in the past, out of one or more feature points that have not set as the positional alignment target of the guide. If it is judged that there are the feature points existing in the similar positions, the recommendation generation unit 1815 generates the guide corresponding to the positions of the feature points as the new guide proposed to be added. Based on the information related to the new guide generated by the recommendation generation unit 1815, a recommendation output unit 1816 generates the GUI component corresponding to the guide and outputs the GUI component to a display control unit 1814. The display control unit 1814 generates the adding proposal screen 1700, on which the GUI component corresponding to the new guide outputted from the recommendation output unit 1816 is superimposed on the GUI component corresponding to the guide already set, the live view image, and so on, and displays the adding proposal screen 1700 on the display device 507.

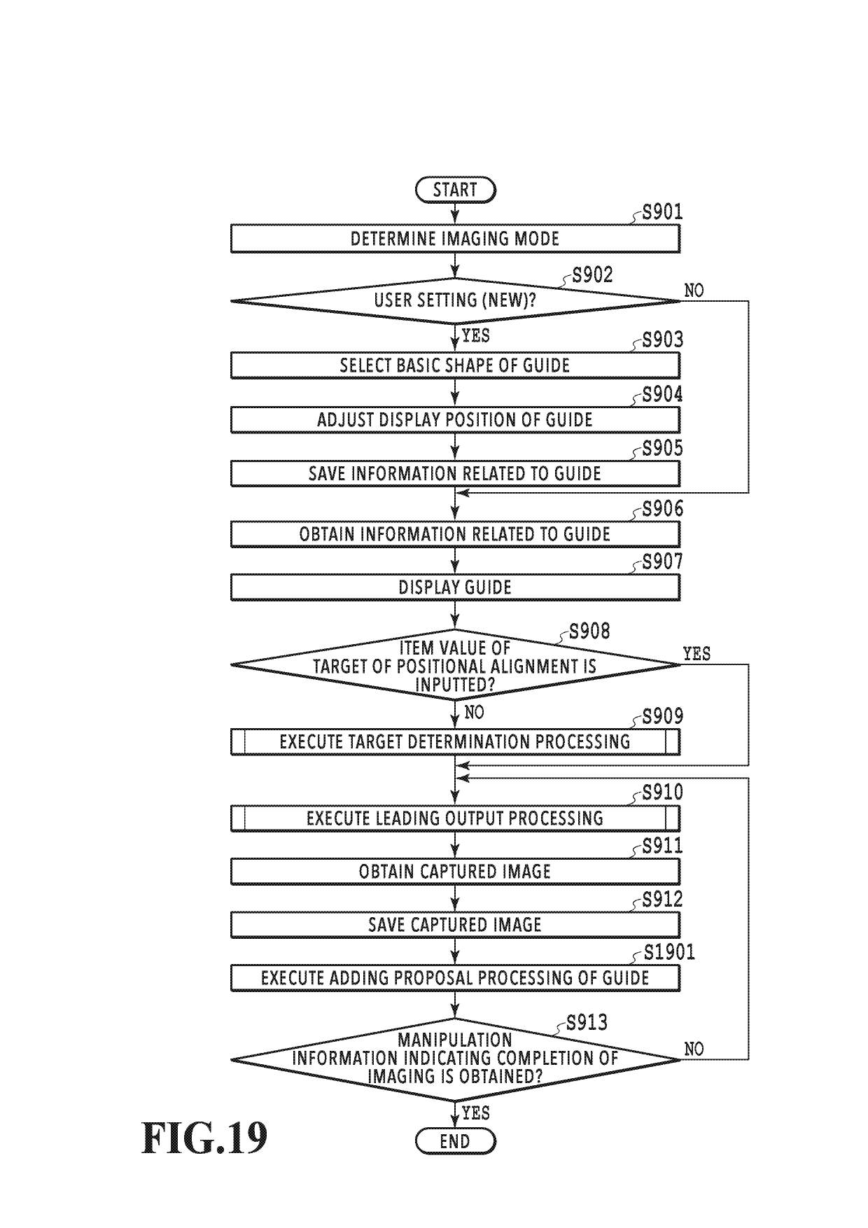

FIG. 19 is a flowchart illustrating an example of a flow of the processing by the imaging apparatus 100 according to embodiment 2. In the description below, description of contents overlapping the description of the flowchart illustrated in FIG. 9 is omitted by providing the same reference sign. After S912, in S1901, the imaging apparatus 100 executes the adding proposal processing of the new guide. After S1901, the imaging apparatus 100 executes the processing in S913.

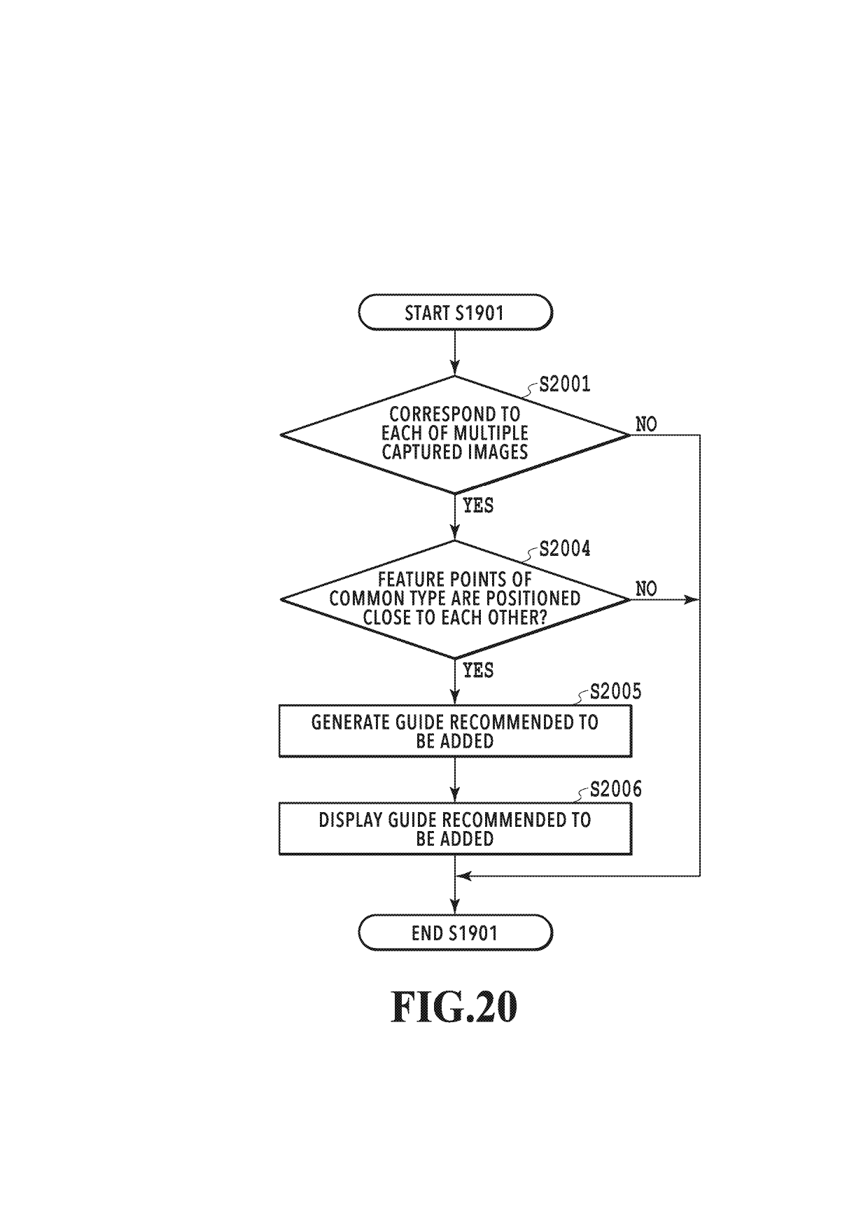

FIG. 20 is a flowchart illustrating an example of a flow of the adding proposal processing by the imaging apparatus 100 according to embodiment 2, in other words, the processing in S1901 in the flowchart illustrated in FIG. 19. In S2001, the recommendation generation unit 1815 judges whether there is the feature point information corresponding to each of the multiple captured images obtained through multiple number of times of imaging in the past, for example, most recently. In S2001, in a case where there is the feature point information corresponding to each of the multiple captured images, the imaging apparatus 100 executes processing in S2004. In S2004, the recommendation generation unit 1815 judges whether there are the feature points that are not the positional alignment target and that are the feature points of common type positioned close to each other, out of the feature point corresponding to each of the multiple captured images.

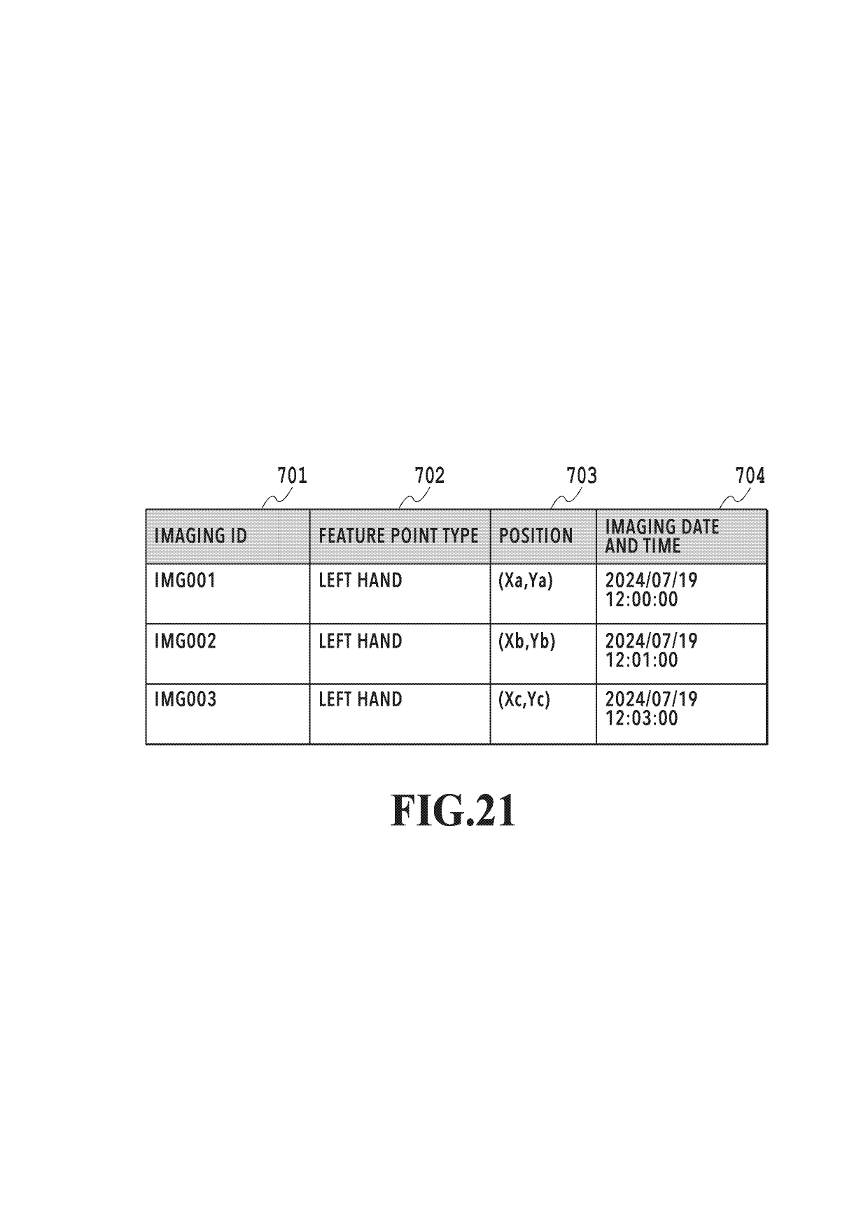

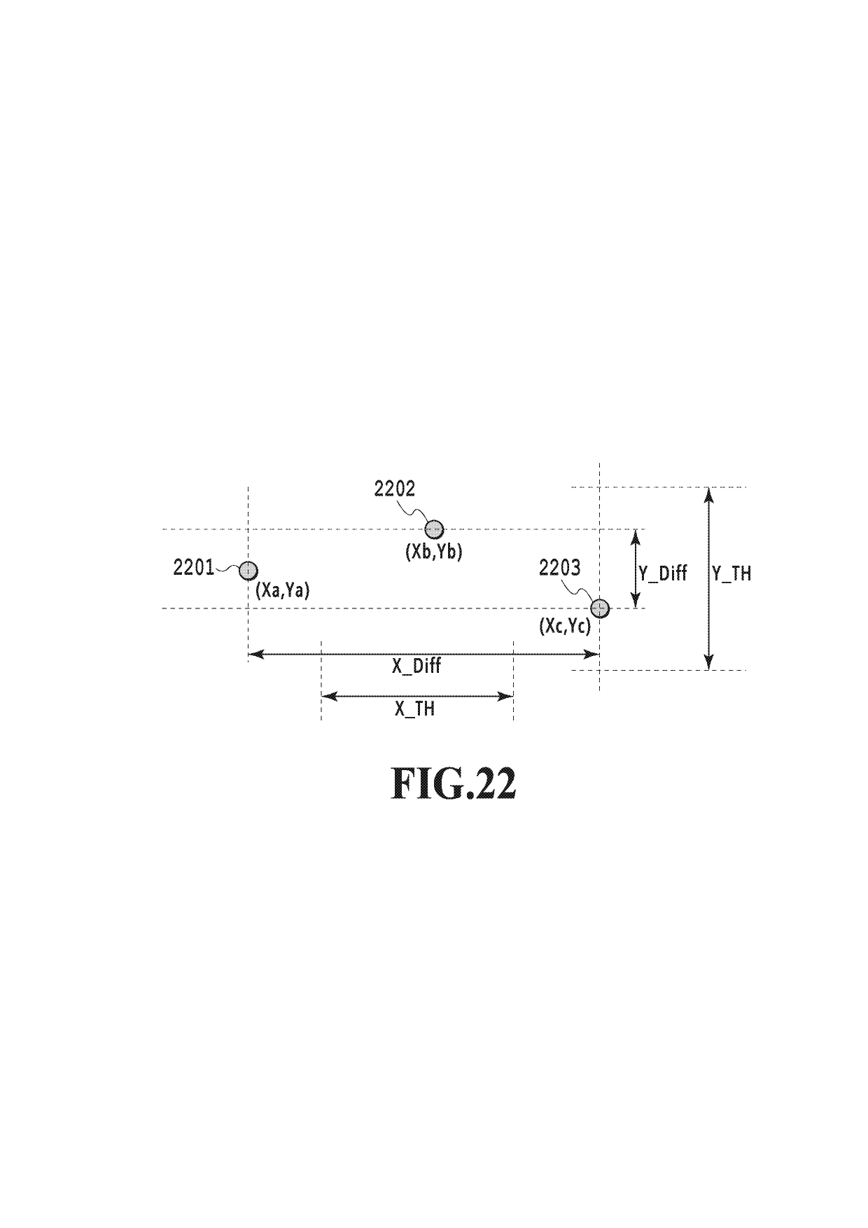

A method of judging whether the feature points are positioned close to each other is described with reference to FIGS. 21 and 22. Hereinafter, as an example, a method of judging whether the feature points included in the three still images obtained by most recent three times of imaging are positioned close to each other is described. FIG. 21 is a diagram illustrating an example of the feature point information that is the judgement target of the feature point by the recommendation generation unit 1815 according to embodiment 2. As an example, the feature point information illustrated in FIG. 21 includes information related to the feature point corresponding to the left hand included in each of the three still images obtained by the most recent imaging.

FIG. 22 is a diagram illustrating an example of a case where the feature point corresponding to the left hand indicated by the feature point information illustrated in FIG. 21 is plotted on the same plane. A circle 2201 is a plotted position of the feature point corresponding to the left hand included in IMG001. Likewise, circles 2202 and 2203 are plotted positions of the feature points corresponding to the left hand included in IMG002 and IMG003, respectively. X_Diff is the horizontal maximum distance of the positions of the feature points of the same type, in other words, in FIG. 22, the feature points corresponding to the left hand. Likewise, Y_Diff is the vertical maximum distance of the positions of the feature points of the same type that are the feature points corresponding to the left hand. For example, in a case of at least one of a case where X_Diff is smaller than X_TH, which is a threshold of the horizontal direction determined in advance, and a case where Y_Diff is smaller than Y_TH, which is a threshold of the vertical direction determined in advance, the recommendation generation unit 1815 judges that the feature points are positioned close to each other.

If it is judged in S2004 that there are the feature points that are not the positional alignment target, and the feature points of the common type are positioned close to each other, the imaging apparatus 100 executes processing in S2005. In S2005, the recommendation generation unit 1815 generates the guide recommended to be newly added. The information related to the guide generated by the recommendation generation unit 1815 is transmitted to the recommendation output unit 1816.

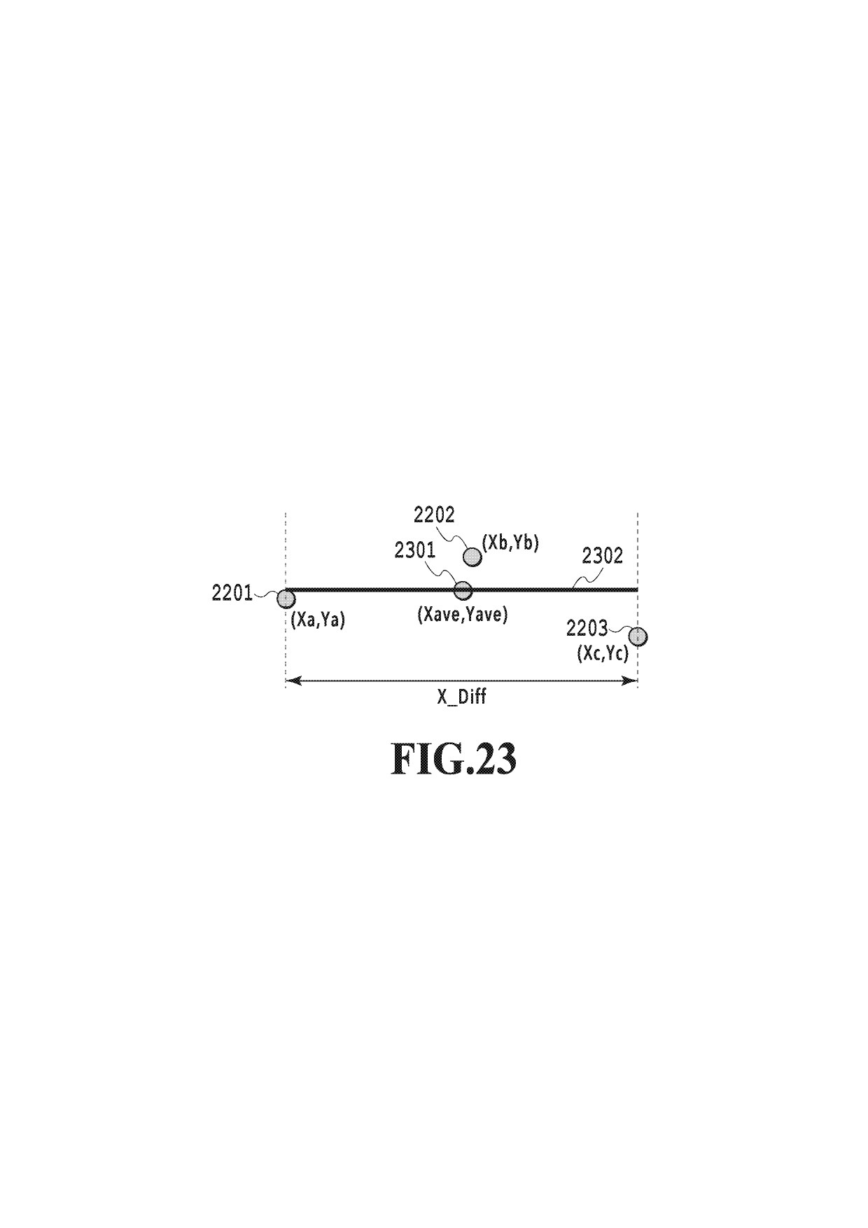

A method of generating the guide by the recommendation generation unit 1815 is described with reference to FIG. 23. FIG. 23 is a diagram illustrating an example of the method of generating the guide by the recommendation generation unit 1815 according to embodiment 2. Specifically, FIG. 23 is a diagram illustrating an example of the guide generated based on the feature point information illustrated in FIG. 21. A circle 2301 is a plotted average value of the positions of the feature points corresponding to the left hand in IMG001, IMG002, and IMG003. A line segment 2302 is the guide generated based on the feature point information illustrated in FIG. 23.

For example, the recommendation generation unit 1815 generates a line segment passing through the position of the circle 2301 as the guide. Specifically, for example, in a case where X_Diff is not smaller than X_TH while Y_Diff is smaller than Y_TH, the recommendation generation unit 1815 judges that the photographer 101 tries to perform imaging by aligning the position of the corresponding feature point in the vertical direction and generates the guide having a linear shape extending in the horizontal direction. Likewise, for example, in a case where X_Diff is smaller than X_TH while Y_Diff is not smaller than Y_TH, the recommendation generation unit 1815 generates the guide having a linear shape extending in the vertical direction. Additionally, for example, in a case where X_Diff is smaller than X_TH while Y_Diff is smaller than Y_TH, the recommendation generation unit 1815 generates the two guides having linear shapes extending in the vertical direction and the horizontal direction.

In the example illustrated in FIG. 23, an example in a case where X_Diff is not smaller than X_TH while Y_Diff is smaller than Y_TH is illustrated, and the guide represented by a line segment 2302 extending in the horizontal direction is generated. Note that, a length of the guide may be arbitrary. In the example illustrated in FIG. 23, a value of the horizontal maximum distance of the positions of the feature points is the length of the guide. Specifically, for example, in a case of generating the guide having the linear shape extending in the horizontal direction, the recommendation generation unit 1815 sets the length of the guide as X_Diff, and in a case of generating the guide having the linear shape extending in the vertical direction, the recommendation generation unit 1815 sets the length of the guide as Y_Diff.

After S2005, in S2006, the recommendation output unit 1816 displays the adding proposal screen including the guide generated in S2005 on the display device 507 via the display control unit 1814. Since an example of the adding proposal screen is illustrated in FIG. 17, the description is omitted. After S2006, in a case where the button 1705 is pressed by the photographer 101, the information related to the guide generated by the recommendation generation unit 1815 is added to the guide information, and thereafter, the imaging apparatus 100 ends the processing of the flowchart illustrated in FIG. 20. Note that, after S2006, in a case where the button 1706 is pressed by the photographer 101, the imaging apparatus 100 ends the processing of the flowchart illustrated in FIG. 20 without adding the information related to the guide generated by the recommendation generation unit 1815 to the guide information.

According to the imaging apparatus 100 formed as described above, it is possible to generate the guide recommended to be newly added based on the captured image obtained by imaging, and it is possible to propose the guide to the photographer 101. The adding of the proposed guide allows the photographer 101 to perform imaging in the similar composition more easily in the subsequent imaging. As a result, according to the imaging apparatus 100 formed as described above, it is possible to assist the photographer to perform imaging properly. Note that, although it is described in the above description assuming that the guide recommended to be added is generated by using the multiple captured images obtained through multiple number of times of imaging, the guide recommended to be added may be generated by using a single captured image obtained by the most recent imaging and the like, for example.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the present disclosure, it is possible to assist a photographer to perform imaging properly.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-204612, which was filed on November 25, 2024 and which is hereby incorporated by reference herein in its entirety.

What is claimed is:

1. An imaging apparatus, comprising:
one or more hardware processors; and
one or more memories storing one or more programs configured to be executed by the one or more hardware processors, the one or more programs including instructions to:
detect a feature point in a captured image;
determine a type corresponding to a feature point being a target of positional alignment with a guide, based on a positional relationship between a feature point detected in a first captured image and the guide; and
output leading information to lead to alignment of a position of a feature point corresponding to the type, out of feature points detected in a second captured image, with a position of the guide, based on a positional relationship between the feature point corresponding to the type and the guide.

2. The imaging apparatus according to claim 1, wherein
the first captured image is obtained by imaging in a state in which the feature point corresponding to the type and being the target of positional alignment with the guide is not determined.

3. The imaging apparatus according to claim 1, wherein
the second captured image is obtained by imaging in a state in which the feature point corresponding to the type and being the target of positional alignment with the guide is determined.

4. The imaging apparatus according to claim 1, wherein
a shape of the guide is a linear shape, a frame shape, or a shape formed of a combination of a line and a frame.

5. The imaging apparatus according to claim 4, wherein the one or more programs further include instructions to:
determine the type corresponding to a feature point existing on the guide as the type of the feature point being the target of positional alignment with the guide in a case where the shape of the guide is a linear shape.

6. The imaging apparatus according to claim 4, wherein the one or more programs further include instructions to:
determine the type corresponding to a feature point existing within a frame corresponding the guide as the type of the feature point being the target of positional alignment with the guide in a case where the shape of the guide is a frame shape.

7. The imaging apparatus according to claim 1, wherein the one or more programs further include instructions to:
obtain manipulation information corresponding to a manipulation input from a user; and
change at least one of the position of the guide and the type of the feature point being the target of positional alignment with the guide based on the manipulation information.

8. The imaging apparatus according to claim 1, wherein the one or more programs further include instructions to:
obtain skeleton information obtained as a result of skeleton estimation performed on a representation of a subject to be imaged in the captured image obtained by imaging as information on the feature point in the captured image.

9. The imaging apparatus according to claim 1, wherein the one or more programs further include instructions to:
obtain object information obtained as a result of object detection performed on the captured image obtained by imaging as information on the feature point in the captured image.

10. The imaging apparatus according to claim 1, wherein the one or more programs further include instructions to:
generate a new guide to be proposed to a user to add, based on the position of the feature point detected in the second captured image.

11. The imaging apparatus according to claim 10, wherein the one or more programs further include instructions to
generate the new guide in a case where feature points of the same type are detected in a plurality of captured images obtained by multiple number of times of imaging.

12. The imaging apparatus according to claim 11, wherein the one or more programs further include instructions to
generate the new guide having a linear shape extending in a horizontal direction in a case where an existing range of the feature points of the same type, out of feature points that are not the target of positional alignment with the guide already set in each of the plurality of captured images, is within a range of a threshold of a vertical direction.

13. The imaging apparatus according to claim 11, wherein the one or more programs further include instructions to
generate the new guide having a linear shape extending in a vertical direction in a case where an existing range of the feature points of the same type, out of feature points that are not the target of positional alignment with the guide already set in each of the plurality of captured images, is within a range of a threshold of a horizontal direction.

14. A control method of an imaging apparatus, the control method comprising:
detecting a feature point in a captured image;
determining a type corresponding to a feature point being a target of positional alignment with a guide, based on a positional relationship between a feature point detected in a first captured image and the guide; and
outputting leading information to lead to alignment of a position of a feature point corresponding to the type, out of feature points detected in a second captured image, with a position of the guide, based on a positional relationship between the feature point corresponding to the type and the guide.

15. A non-transitory computer readable medium storing a program for causing a computer to perform a control method of imaging apparatus, the control method comprising:
detecting a feature point in a captured image;
determining a type corresponding to a feature point being a target of positional alignment with a guide, based on a positional relationship between a feature point detected in a first captured image and the guide; and
outputting leading information to lead to alignment of a position of a feature point corresponding to the type, out of feature points detected in a second captured image, with a position of the guide, based on a positional relationship between the feature point corresponding to the type and the guide.
